(19) United States
(12) Patent Application Publication
(10) Pub. No.: US 2005/0086647 A1
(43) Pub. Date: Apr. 21, 2005

(54) Apparatus for and method of creating computer program specifications, and computer program product

(75) Inventors: Hidenobu Ito, Kawasaki (JP); Akihiko Matsuo, Kawasaki (JP); Toshiaki Gomi, Kawasaki (JP); Manabu Kamimura, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/786,086

(22) Filed: Feb. 26, 2004

(30) Foreign Application Priority Data
Oct. 15, 2003 (JP) 2003-355695

(51) Int. Cl. G06F 9/44

(52) U.S. Cl. 717/132; 717/133

(57) ABSTRACT

A method of creating computer program specifications includes creating the structure information that indicates a relation between program call structure and data input-output information of the computer program source code by analyzing a computer program source code. The method also includes creating process-outline information of the computer program source code from a part of the structure information, after the creating of the structure information. The method further includes creating computer program specifications of the computer program source code by using the process-outline information, after the creating of the process-outline information.

### BACKGROUND OF THE INVENTION

1) Field of the Invention

The present invention relates to a computer program product, and an apparatus for and a method of creating documents that define the specification of the computer program, which facilitate software maintenance by providing an overview of a software process flow for a maintenance personnel such as an administrator, a supervisor, or a programmer.

2) Description of the Related Art

To maintain software or to develop new software from the existing software, you must understand the specification of the computer program. However, it is difficult to capture the whole structure by just reading computer programs because they are usually optimized for execution and not comprehensible for human. Especially, in a case of large-scale software that includes a large number of programs, it is a painful job to understand to overall process just from a source computer program. Therefore, for maintenance and development of software, it is usual to define the process flow of the computer program as specifications in an easily understandable-form.

Particularly, in Application Portfolio Management (APM) service that undertakes the maintenance and enhancement of software, specifications must be clearly defined in advance because sometimes the personnel may have no knowledge of the target system.

However, in most of the cases, specifications of software are prepared during development of computer program so corrections and changes that are incorporated after the release of software may not be included in the specifications. As a result, the specifications can be out of date and are not bound to be fully reliable. There can be some cases where no specifications are preserved. Therefore, it is extremely important to maintain reliable specifications from point of view of software maintenance.

Specifications information is often entered as comments on a computer program, but no one can guarantee that the comments define the specification of the current system.

So far, attempts have been made to generate specifications automatically by mechanical analysis of a call structure of the computer program. The technologies employed in these attempts have been disclosed in Japanese Patent Application Laid-open Publication No. 2000-215391 and “SIMPLIA SERIES” downloaded on Sep. 25, 2003 from http://software.fujitsu.com/jp/simplia/.

The analysis and display of the call structure of the computer program according the conventional technology only supports to understand the detailed structure of the computer program, and the outline of the process flow which is the most important for capturing the whole process of the computer program cannot be supported. Particularly, in the conventional technology, the relation between input-output information and the call structure of the computer program, which is the most important information for understanding of outline of the computer program, is not available.

Further, the documents of the specification may contain some information, which user added manually after generating the documents from the computer program automatically to aid understanding of the computer program, though, when the specifications are regenerated automatically with the correction in the computer program, such information cannot be updated to the new generated specifications. Therefore, the user has to write and copy the information manually.

To understand an overall job process that is performed by executing a plurality of computer programs, specifications of outline of the overall job process is necessary rather than specifications for individual programs. The specifications of outline of the overall job process cannot be generated just by analyzing the individual computer programs.

### SUMMARY OF THE INVENTION

It is an object of the present invention to solve the problems in the conventional technology.

A computer program product according to one aspect of the present invention includes computer executable instructions stored on a computer readable medium, wherein the instructions, when executed by the computer, cause the computer to perform the following: (1) creating, by analyzing a computer program source code, structure information that defines the relation between a program call structure and data input-output information of the computer program source code; (2) creating process-outline information of the computer program source code from a part of the structure information; and (3) creating computer program specifications of the computer program source code by using the process-outline information.

An apparatus for creating computer program specifications according to another aspect of the present invention includes first, second, and third creators. The first creator creates, by analyzing a computer program source code, structure information that defines the relation between program call structure and data input-output information of the computer program source code. The second creator creates process-outline information of the computer program source code from a part of the structure information. The third creator creates computer program specifications of the computer program source code by using the process-outline information.

A method of creating computer program specifications according to still another aspect of the present invention realizes, as a method, the instructions included in the computer program product according to the present invention.

The other objects, features, and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a block diagram that defines the function of a specification creator according to a first embodiment of the present invention;

FIG. 2 is an illustration of a subroutine call extracted by a structure extractor;

FIG. 3 is an example of a data structure of subroutine information stored in subroutine information storage;

FIG. 4 is an illustration of a connection (tree structure) of a subroutine information list;

FIG. 5 is an example of a data structure of a list of call conditions shown in FIG. 3;

FIG. 6 is an example of a data structure of a list of input-output information shown in FIG. 3;

FIG. 7 is an illustration of process-outline information generated by a process-outline creator;

FIG. 8 is an example of computer program specifications generated by a document creator;

FIG. 9 is a flow chart of a processing procedure of subroutine information generation by a structure extractor and condition branching information extraction by condition branching information extractor;

FIG. 10 is a flow chart of a processing procedure of input-output information extraction by input-output data extractor;

FIG. 11 is a flow chart of a procedure of addition of input-output information by a structure-input-output data relation creator to subroutine information storage;

FIG. 12 is a flow chart of a processing procedure of process-outline generation by the process-outline creator;

FIG. 13 is an illustration of comment inheritance according to a second embodiment of the present invention;

FIG. 14 is a block diagram that defines the function of a specification creator according to the second embodiment;

FIG. 15 is an example of a data structure of a property corresponding to a list of comment entry field;

FIG. 16A is an example of a data structure of a property corresponding to a comment entry field;

FIG. 16B is an example of a data structure of a property corresponding to comment entry field when there is a plurality of entry fields;

FIG. 17 is a flow chart of a processing procedure of a comment entry inheritor shown in FIG. 14;

FIG. 18 is an example of a comment entry field of computer program specifications using a spreadsheet;

FIG. 19 is an example of a data structure of a property corresponding to a comment entry field of computer program specifications using a spreadsheet;

FIG. 20 is an example of a data structure of a property corresponding to a comment entry field (when there is a plurality of entry fields) of computer program using a spreadsheet;

FIG. 21 is an illustration of a comment entry field in a process structural diagram;

FIG. 22 is an example of position-information data of each comment entry field in the process structural diagram shown in FIG. 21;

FIG. 23 is a functional block diagram of a specification creator according to a third embodiment of the present invention;

FIG. 24 is a block diagram that defines the function of a computer program-outline creator;

FIG. 25A is an example of a computer program source;

FIG. 25B is computer program intermediate information that is generated from the computer program source shown in FIG. 25A;

FIG. 26 is an example of classification of significance levels of data;

FIG. 27 is an example of the significance level that is added to a tag for variables of the computer program intermediate information;

FIG. 28 is an example of classification of significance levels of statements;

FIG. 29 is an example of a significance level that is added to a tag of statement of the computer program intermediate information;

FIG. 30 is an illustration of an initial operation of a summarizing management section;

FIG. 31 is a diagram of interfaces (I/F) between the summarizing management section and a summarizing processing computer program;

FIG. 32 is an example of an order of execution maintained of the summarizing processing computer program;

FIGS. 33A to 33D are rule examples of summarizing (local) that is executed by the summarizing processing computer program;

FIGS. 33E and 33F are rule examples of summarizing (overall) that is executed by the summarizing processing computer program;

FIG. 34 is an illustration of processing by a Japanese language converter;

FIGS. 35A and 35B are other examples of a Japanese template;

FIG. 36 is a computer program sample;

FIG. 37 is a list of summarizing processing computer programs that are used by the summarizing management section;

FIG. 38 is an illustration of an order of execution of the summarizing processing computer program;

FIG. 39 is computer program intermediate information at the end of the summarizing processing;

FIG. 40 is a representation of Japanese information that is generated by the Japanese language converter;

FIG. 41 is an example of a computer program-outline that is generated by the document creator;

FIG. 42 is a block diagram that defines the function of a specification creator according to a fourth embodiment of the present invention;

FIG. 43 is a flow chart of a processing procedure of an input-output judging process by a job-step input-output data extractor;

FIG. 44 is a flow chart of a processing procedure of a file input-output judging process as an overall job by an overall input-output information extractor;

FIG. 45 is a flow chart of a processing procedure of a utility exclusion process;

FIG. 46 is an example of a batch-job script;

FIG. 47 is a tabular representation of batch-job analysis information that is generated by a batch-job script language syntax analyzer from the batch-job script shown in FIG. 46;

FIG. 48 represents a process-outline of an overall batch job that is generated from the batch-job script shown in FIG. 46;

FIG. 49 is a functional block diagram of a specification creator according a fifth embodiment of the present invention;

FIG. 50 is an example of screen definitions;

FIG. 51 is an example of screen transition information;

FIG. 52 is an example of screen transition data;

FIGS. 53A and 53B are examples of a screen transition diagram;

FIG. 54 is a block diagram that defines the function of a specification creator according to a sixth embodiment of the present invention;

FIG. 55 is a flow chart of a processing procedure of the dictionary reference service;

FIG. 56 is a flow chart of a processing procedure of a process structure creator;

FIG. 57A represents a target program (call origin) that generates the process structural diagram;

FIG. 57B represents a target program (call target) that generates the process structural diagram;

FIG. 58 is an example of the process structural diagram that is generated from programs shown in FIGS. 57A and 57B;

FIG. 59 is a block diagram that defines the function of a specification creator according to a seventh embodiment of the present invention;

FIG. 60 is a flow chart of a processing procedure of an execution log information analyzer;

FIG. 61 is a flow chart of a processing procedure of an execution information integrator;

FIG. 62 is an example of a process structural diagram that is generated from the computer programs shown in FIGS. 57A and 57B;

FIG. 63 is an illustration of a computer system that executes specification generating computer program according to the first to seventh embodiments;

FIG. 64 is a block diagram of a main section shown in FIG. 63; and

FIG. 65 is an example of comment inheritance in which a space for user's entry is not provided.

### DETAILED DESCRIPTION

Exemplary embodiments of a computer program product, and an apparatus for and a method of creating computer program specifications are described in detail with reference to attached diagrams. The embodiments of the present invention are described by referring mainly to a case of applying it to a computer program that is developed in COBOL.

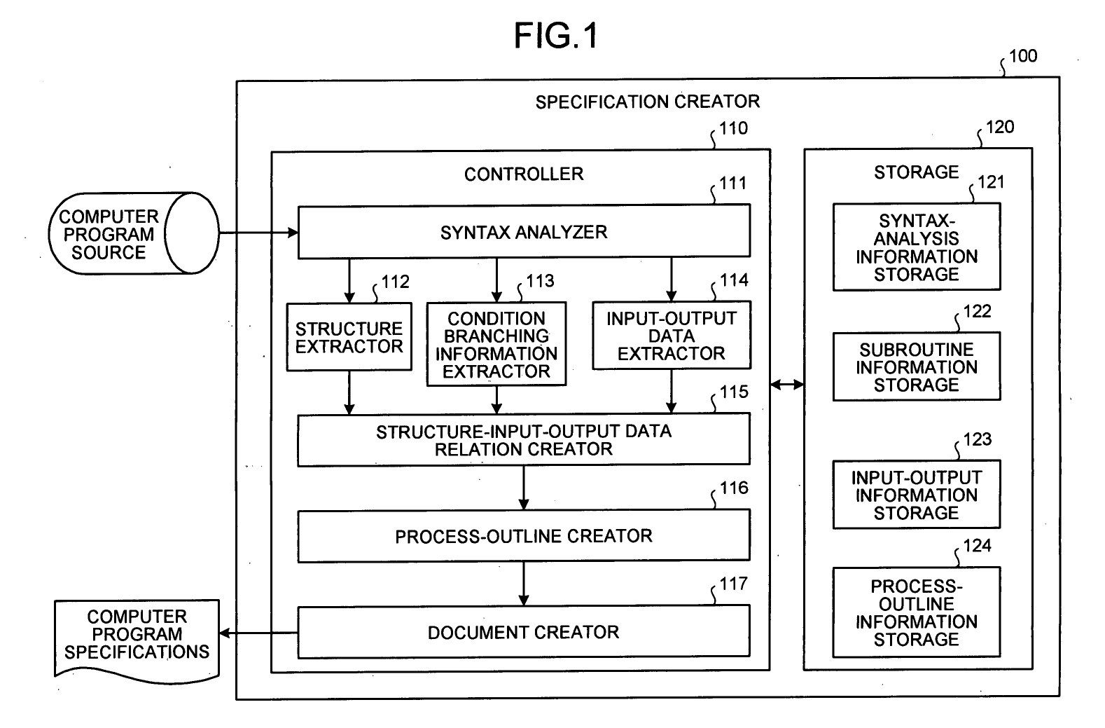

The composition of a specification creator according to a first embodiment is described below. FIG. 1 is a functional block diagram of the specification creator. The specification creator 100 includes a controller 110 and a storage 120. The controller 110 prepares computer program specifications from a computer program source. The storage 120 stores intermediate results of process performed by the controller 110.

The controller 110 includes a syntax analyzer 111, a structure extractor 112, a condition branching information extractor 113, an input-output data extractor 114, a structure-input-output data relation creator 115, a process-outline creator 116, and a document creator 117. The storage 120 includes a syntax-analysis information storage 121, a subroutine information storage 122, an input-output information storage 123, and a process-outline information storage 124.

The syntax analyzer 111 reads a computer program source, then extracts information of statements and variables from the computer program source, and generates syntax analysis information. The syntax-analysis information storage 121 stores the syntax analysis information generated.

The structure extractor 112 reads the syntax analysis information from the syntax analysis information storage 121 and determines a call target in a subroutine call in the computer program. The structure extractor 112 then extracts a call structure of the computer program according to an execution order as subroutine information.

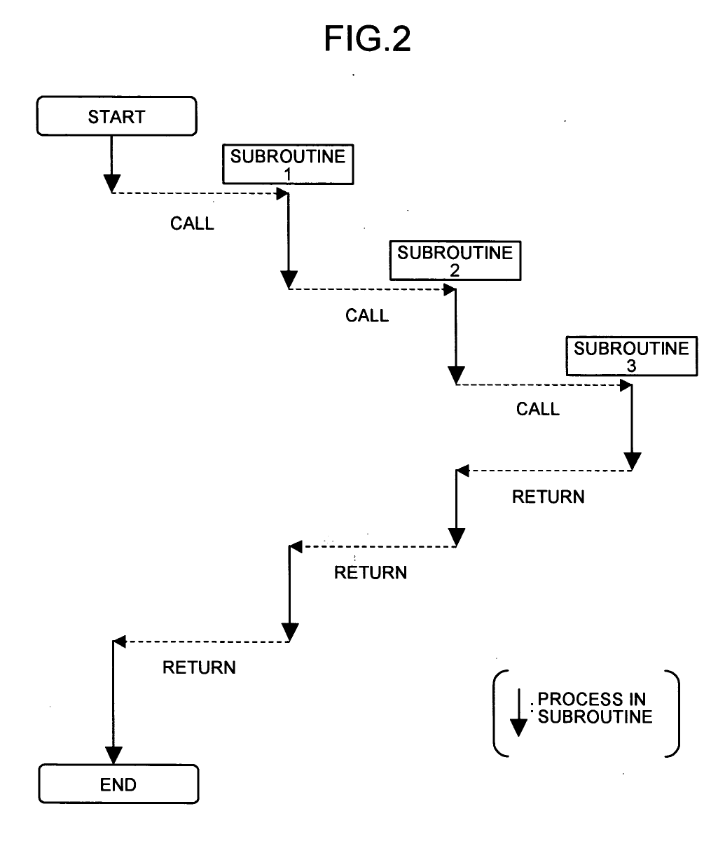

FIG. 2 is an illustration of a subroutine call that is extracted by the structure extractor 112. According to FIG. 2, a certain program calls a subroutine 1, the subroutine 1 calls a subroutine 2, and the subroutine 2 calls a subroutine 3.

Subroutine indicates both cases viz. when a computer program calls another program (CALL statement in COBOL) and when the computer program calls a group of processes included in the program (PERFORM statement in COBOL).

When the subroutine 3 is executed, the control returns to the subroutine 2. When the subroutine 2 is executed, the control returns to the subroutine 1. When the subroutine 1 is executed, the control returns to an original computer program. The structure extractor 112 extracts a structure of such computer program and generates subroutine information.

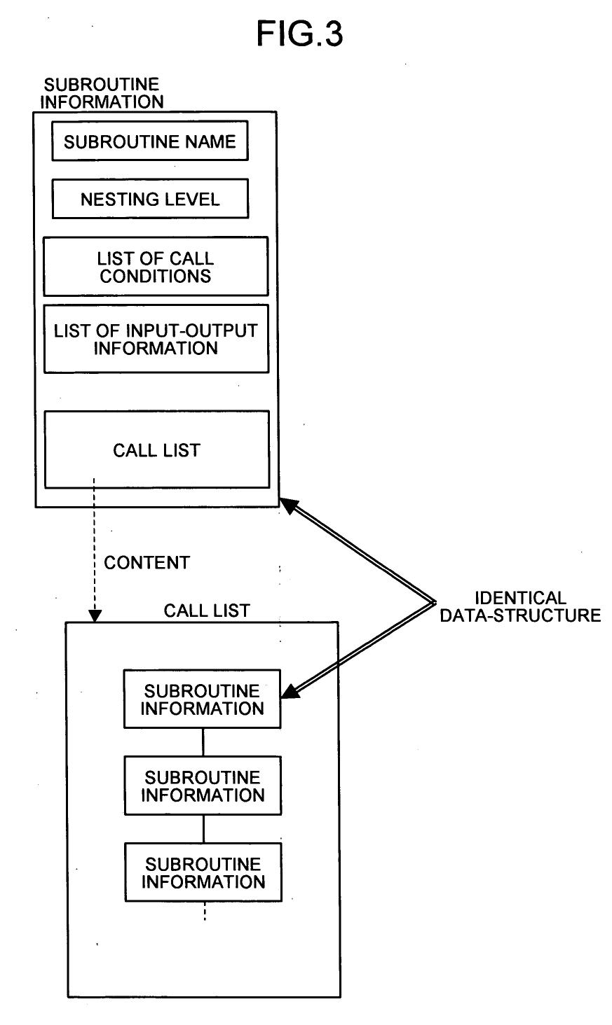

The subroutine information storage 122 stores the subroutine information that is generated by the structure extractor 112. FIG. 3 is an example of a data structure of the subroutine information stored in the subroutine information storage 122.

The subroutine information includes a subroutine name, a nesting level that indicates depth of a call, a list of call conditions, a list of input-output information, and a call list. The list of call conditions includes conditions when a subroutine is called. The list of input-output information includes information of input and output by the subroutine. The call list includes subroutine information of the subroutine called by the subroutine. When the subroutine does not have a name like main routine etc., a null character is set.

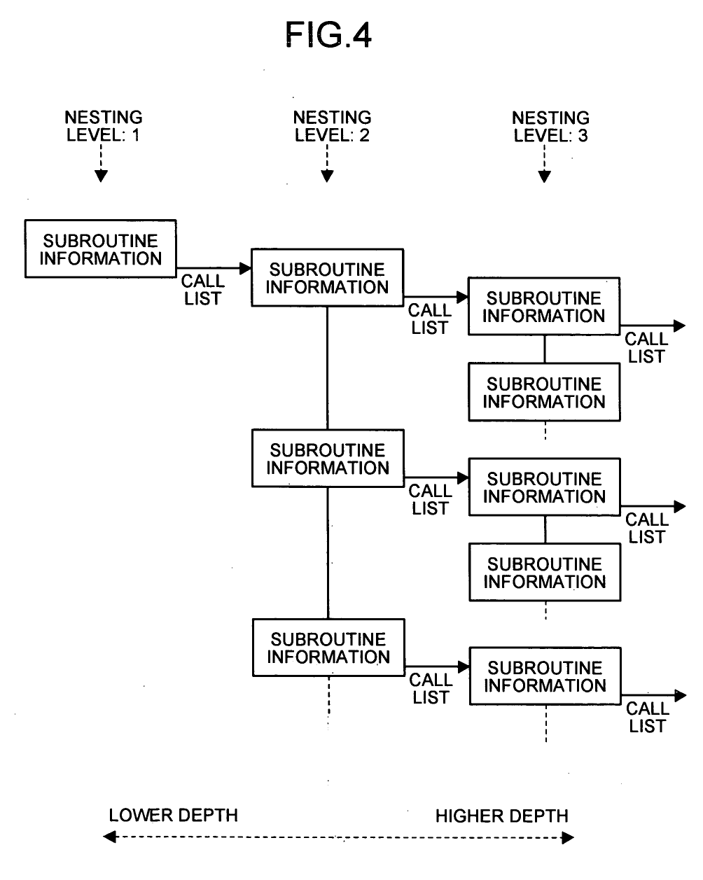

The call list includes subroutine information that has a similar data structure. FIG. 4 is an illustration of a connection (tree structure) of the subroutine information list. A call list of the subroutine information that has the nesting level 1, includes a list of subroutine information that has the nesting level 2. A call list of the subroutine information that has the nesting level 2 includes a list of subroutine information that has the nesting level 3. Thus, the subroutine information as a whole, is in a form of the tree structure.

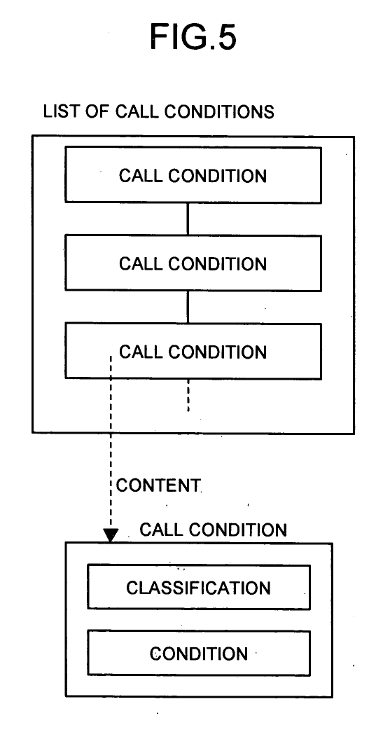

FIG. 5 is an example of a data structure of the list of call conditions shown in FIG. 3. Each call condition that is included in the list of call conditions includes a condition classification and a condition entry. The condition type is a type of conditions like loop conditions in a loop statement and a branching condition in an IF statement or a SWITCH statement. i<100 is an example of a condition.

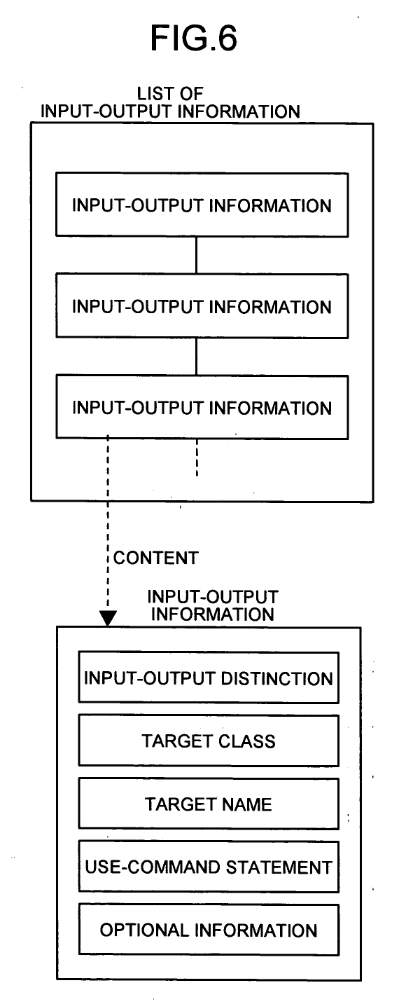

FIG. 6 is an example of a data structure of a list of input-output information shown in FIG. 3. Input output information that is included in the list of input-output information includes an input-output distinction, a target type, a target name, a use-command statement, option information etc. The input-output distinction indicates whether it is an input or an output. The target type indicates whether the input-output target is a database or a file. The target name indicates a name of the input-output target. The use-command statement indicates an input-output command that is used for input and output. The option information includes other information that is particular to the target.

The condition branching information extractor 113 generates the list of call condition shown in FIG. 5 from the syntax-analysis information stored in the syntax-analysis information storage 121. The list of call conditions generated by the condition branching information extractor 113 is stored in the subroutine information storage 122.

The input-output data extractor 114 reads the syntax analysis information stored in the syntax-analysis information storage 121 and generates the list of input-output information shown in FIG. 6 for each subroutine. The input-output information storage 123 stores the list of input-output information generated by the input-output data extractor 114 associating with the subroutine name.

The structure-input-output data relation creator 115 associates the call structure of the computer program with list of input-output information stored in the input-output information storage 123. Concretely, the structure-input-output data relation creator 115 stores the list of input-output information that is stored in the input-output creator 123 as a list of input-output information of the corresponding subroutine information in the subroutine information storage 122.

Due to the associating of the input-output information with the call structure of the computer program by the structure-input-output data relation creator 115, the specification creator 100 can generate computer program specifications in which the call structure of the computer program is associated with the input-output information.

The process-outline creator 116 generates process-outline information of the computer program from the subroutine information in which the list of input-output information is stored by the structure-input-output data relation creator 115. The process-outline information storage 124 stores the process-outline information that is generated by the process-outline creator 116.

The process-outline creator 116 performs following processes to generate the process-outline information: (1) Extraction of only that subroutine information for which a nesting level is in a specific range (for example 2 and 3); (2) Exclusion of subroutine information that does not includes specific words (for example, ERROR, FAULT, INITIALIZE etc.) in a subroutine name; (3). Leaving subroutine information that performs input and output; and (4) Leaving subroutine information that includes loop handling.

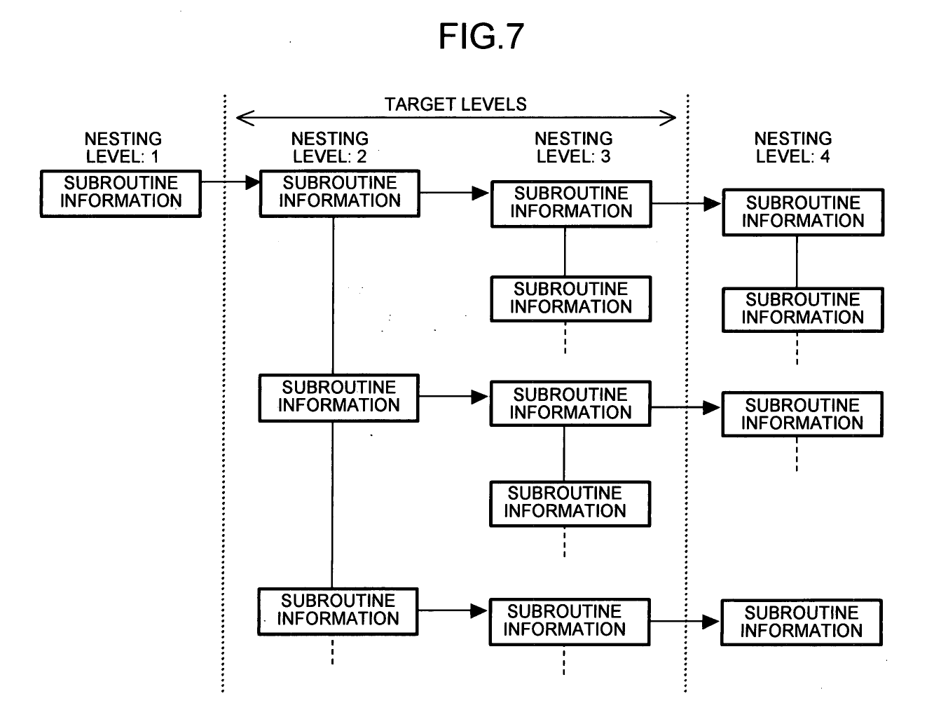

FIG. 7 is an illustration of process-outline information generated by the process-outline creator 116. In this case, the process-outline information is prepared by extracting only the subroutine information for which the nesting level is 2 and 3.

Thus, due to generation of the process-outline information of the computer program from the subroutine information by the process-outline creator 116, the specification creator 100 can generate compute program specifications that indicate process-outline in which the input output information is associated with the call structure of the computer program.

The process-outline creator 116 generates information that is necessary for diagrammatic illustration of input output file of the computer program, information about common area used by the computer program, and information about files that are input and output by the computer program. The process-outline creator 116 stores this information in the process-outline information storage 124.

The document creator 117 generates the computer program specification by using the process-outline information that is stored in the process-outline information storage 124. Concretely, the document creator 117 forms the process-outline information in a predetermined format and outputs the information as computer program specifications.

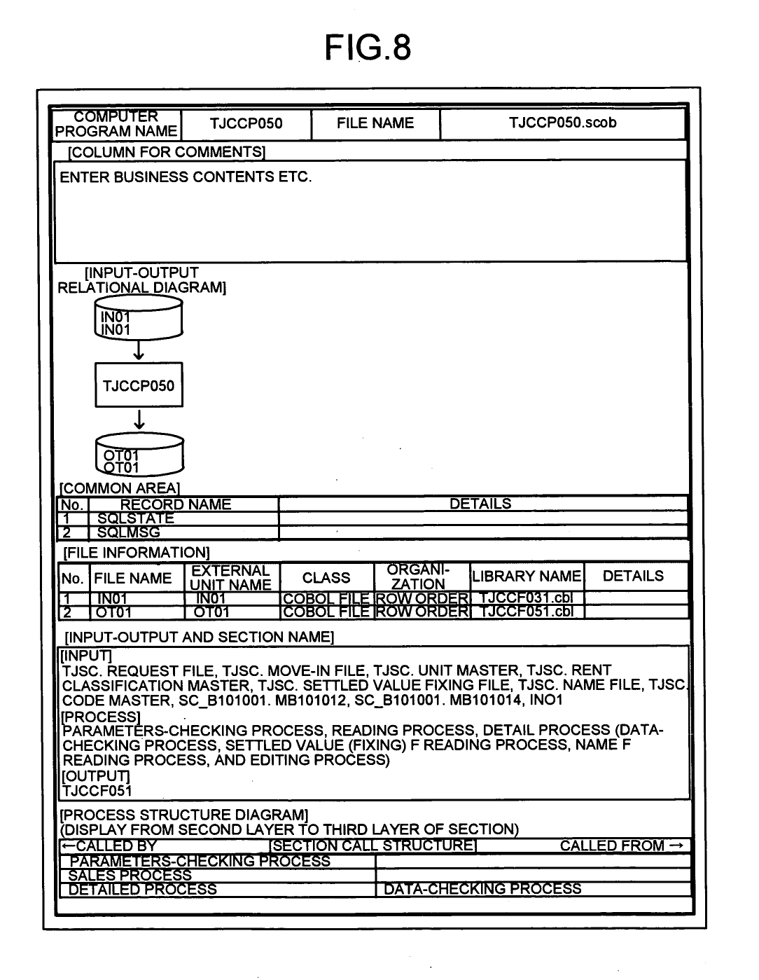

FIG. 8 is an example of computer program specifications generated by the document creator 117. The computer program specifications includes a COMPUTER PROGRAM NAME, a FILE NAME i.e. a name of a file that stores the computer program, a COLUMN FOR COMMENTS, an INPUT-OUTPUT RELATIONAL DIAGRAM, a COMMON AREA, FILE INFORMATION, INPUT-OUTPUT AND SECTION NAME, and a PROCESS STRUCTURE DIAGRAM.

The COLUMN FOR COMMENTS is used by the user to enter comments like business information, operational know how. The INPUT-OUTPUT RELATIONAL DIAGRAM is used to illustrate the input-output files of the computer program. The COMMON AREA is used for indicating a record name of a common area that is used by the computer program. The FILE INFORMATION indicates information about files that are input and output by the computer program.

The INPUT-OUTPUT AND SECTION NAME indicates input-output information that is included in a subroutine name and subroutine information that are extracted, as process-outline information. The section is a type of subroutine and in this case, the subroutine is substituted by the section. In this example, information about a section that has the nesting level of 2 and 3 is indicated as the process-outline information.

In other words, PARAMETER-CHECKING PROCESS, READING PROCESS, and DETAIL PROCESS are indicated as the section that has a nesting level 2. DATA-CHECKING PROCESS, SETTLED VALUE (FIXING) F READING PROCESS, NAME F READING PROCESS, and EDITING PROCESS are indicated as the section that has a nesting level 3 called by the DETAIL PROCESS.

The input-output information in the subroutine information of these sections includes, TJSC. REQUEST FILE, TJSC. MOVE-IN FILE, TJSC. UNIT MASTER, TJSC. RENT CLASSIFICATION MASTER, TJSC. SETTLED-VALUE FIXING FILE, TJSC. NAME FILE, TJSC. CODE MASTER, SC_B101001. MB101012, SC_B101001. MB101014, and IN01 as input and TJCCF051 as output.

The PROCESS STRUCTURE DIAGRAM indicates call structure of the subroutine that is extracted as the process-outline information. In this example, PARAMETERS-CHECKING PROCESS, READING PROCESS, AND DETAIL PROCESS are indicated as the section that has a nesting level 2 and DATA-CHECKING PROCESS that has a nesting level 3 called by the DETAIL PROCESS is indicated.

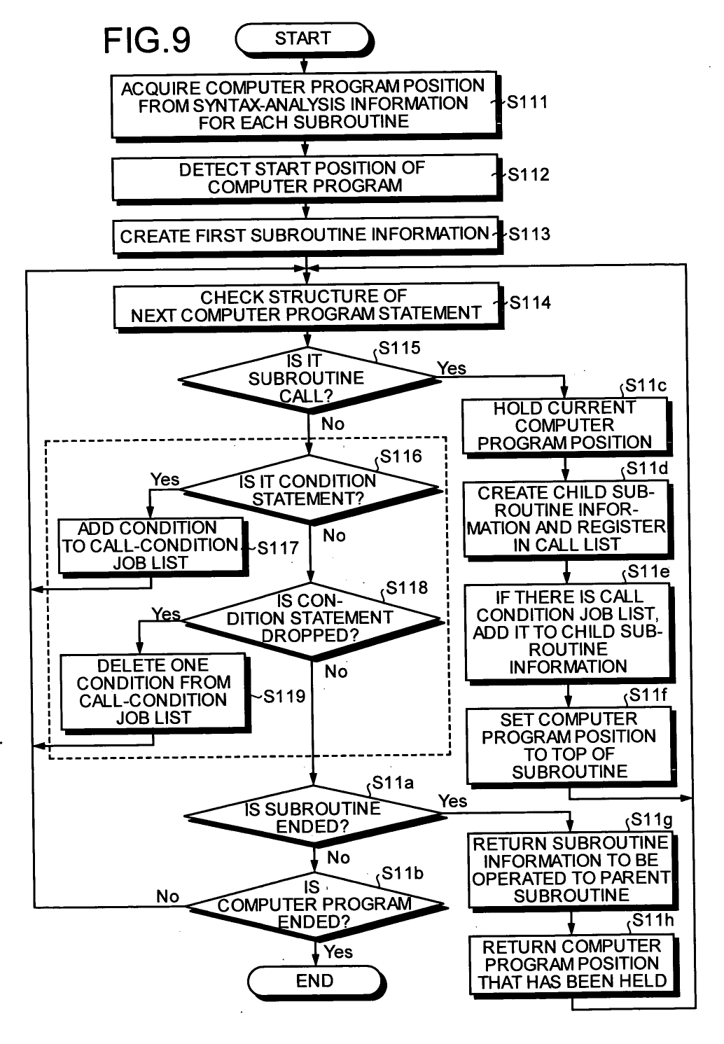

Subroutine information generation by the structure extractor 112 and condition branching information extraction by the condition branching information extractor 113 is described below. FIG. 9 is a flow chart of a processing procedure of the subroutine information generation by the structure extractor 112 and the condition branching information extraction by the condition information extractor 113. An area indicated by broken lines includes the condition branching information extraction by the condition branching information extractor 113 and the remaining area includes the subroutine information generation by the structure extractor 112.

To start with, the structure extractor 112 acquires for each subroutine a computer program position from the syntax-analysis information stored in the syntax-analysis information storage 121 (step S111) and detects a starting position of the computer program (step S112).

The structure extractor 112 prepares first subroutine information (step S113), checks a structure of the next computer program statement of the starting position (step S114), and makes a judgment of whether it is a subroutine call (step S115). PERFORM and CALL are computer program statements that perform subroutine call.

When there is a subroutine call, the structure extractor 112 holds the present computer program position (step S11c), creates subroutine information corresponding to a child subroutine, and registers the subroutine information in the call list (step S11d). If there is a call condition job list, the structure extractor 112 adds to the child subroutine information (step S11e). The structure extractor 112 shifts the computer program position to the top of the subroutine (step S11f), the process returns to step S114 and the structure extractor 112 checks a structure of the next computer program.

If it is not a subroutine call, the condition branching information extractor 113 makes a judgment of whether it is a condition statement (step S116). If it is a condition statement, the condition branching information extractor 113 adds a condition to the call condition job list (step S117), the process returns to step S114, and the condition branching information extractor 113 checks structure of the next computer program statement.

If it is not a condition statement, the condition branching information extractor 113 makes a judgment of whether the condition statement is dropped (step S118). If the condition statement is dropped, the condition branching information extractor deletes one condition from the call condition job list (step S119), the process returns to step S114, and the condition branching information extractor 113 checks structure of the next computer program statement.

Moreover, if the condition statement is not dropped, the structure extractor 112 makes a judgment of whether the subroutine is ended (step S11a). If the subroutine is not ended, the structure extractor 112 makes a judgment of whether the computer program is ended (step S11b). If the computer program is not ended, the process returns to step S114 and the structure extractor 112 checks the next computer program statement. If the computer program is ended, the structure extractor 112 ends the process.

On the other hand, if the subroutine is ended, the structure extractor 112 returns subroutine information operated to a parent subroutine (step S11g) and returns a position of the computer program checked to a computer program position of the parent held (step S11h). The process returns to step S114 and the structure extractor 112 checks a structure of the next computer program statement.

Thus, the structure extractor 112 can extract a call structure of the computer program from the computer program by creating the subroutine information by checking the subroutine call and the subroutine end in the computer program.

The condition branching information extractor 113 checks the condition statement and holds the condition statement in the call condition job list. If there is a subroutine call, the structure extractor 112 can extract a call condition of the subroutine call by registering the condition from the call condition job list in the call condition list of the subroutine information.

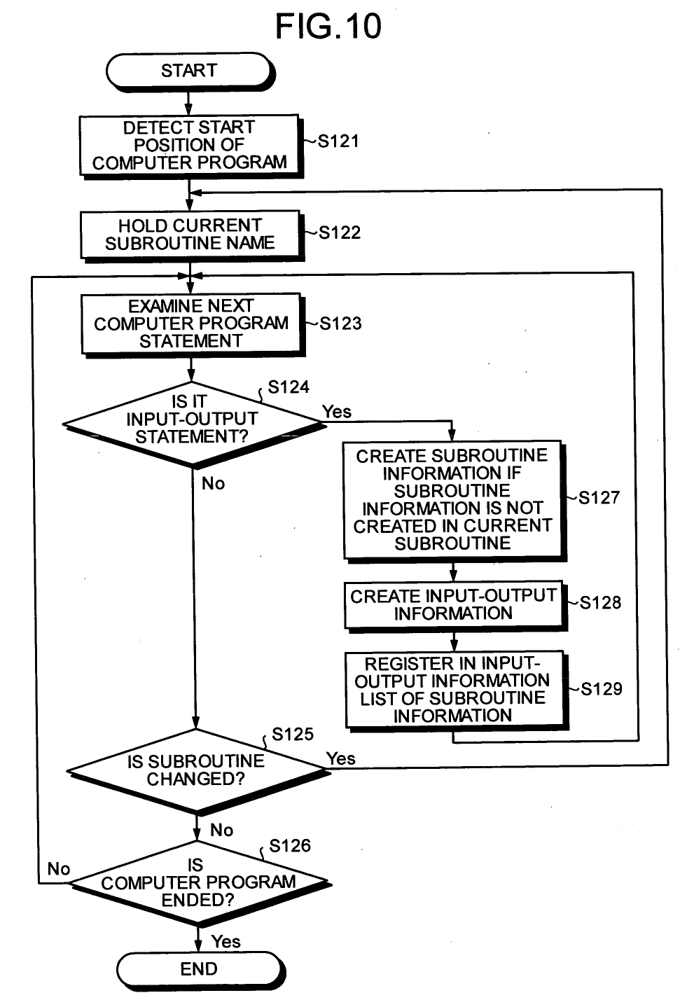

A processing procedure of the input-output information extraction by the input-output data extraction 114 is described below. FIG. 10 is a flow chart of a processing procedure of input-output extraction by the input-output data extractor 114.

The input-output data extractor 114 detects a starting position of the computer program from the syntax-analysis information that is stored in the syntax-analysis information storage 121 (step S121). The input-output data extractor 114 also detects the current subroutine name (step S122).

Further, the input-output data extractor 114 checks the next computer program statement (step S123) and makes a judgment of whether the computer program statement is an input-output statement (step S124). READ, WRITE etc. are input-output statements.

If the computer program statement is an input-output statement, the input-output data extractor 114 checks if the subroutine information is created in the input-output information storage 123 with the current subroutine. If the subroutine information is not created, the input-output data extractor 114 creates the subroutine information and registers the subroutine information created in the input-output information storage 123 (step S127).

The input-output data extractor 114 creates the input-output information from the input-output statement (step S128) and adds the input-output information to the subroutine information stored in the input-output information storage 123 (step S129). The process returns to step S123 and the input-output extractor 114 checks the next computer program statement.

On the other hand, if the computer program statement is not an input-output statement, the input-output data extractor 114 checks if the subroutine is changed (step S125). If the subroutine is changed, the process returns to step S122 and the input-output data extractor 114 hold a name of the subroutine changed as the current subroutine name.

If the subroutine is not changed, the input-output data extractor 114 checks if the computer program is ended (step S126). If the computer program is not ended, the process returns to step S123 and the input-output data extractor checks the next program statement. If the computer program is ended, the input-output data extractor 114 ends the process.

Thus, the input-output data extractor 114 can associate the subroutine with the input-output information by extracting the input-output information from the computer program, associating the input-output information with the subroutine that performs input and output, and storing the input-output information associated in the input-output information storage 123.

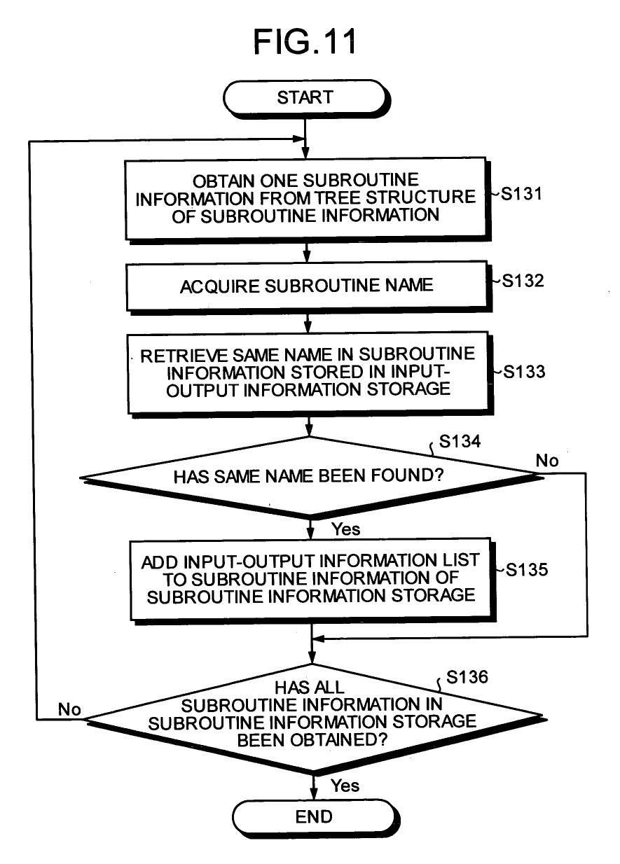

A processing procedure of addition of the input-output information by the structure-input-output data relation creator 115 to the subroutine information storage 122 is described below. FIG. 11 is a flow chart of the processing procedure of addition of input-output information by the structure-input-output data relation creator 115 to the subroutine information storage 122.

The structure-input-output data relation creator 115 acquires one subroutine information from the tree structure of the subroutine information stored in the subroutine information storage 122 (step S131). The structure-input-output data relation creator 115 acquires a subroutine name (step S132) and searches for a subroutine that has same name from the subroutine information stored in the input-output information storage 123 (step S133).

The structure-input-output data relation creator 115 makes a judgment of whether the subroutine with the same name is found (step S134). If the subroutine with the same name is found, the structure-input-output data relation creator 115 adds the input-output information stored in the input-output information storage 123 to the corresponding subroutine information in the subroutine information storage 122 (step S135).

The structure-input-output data relation creator 115, then makes a judgment of whether all the subroutine information in the subroutine information storage 122 is obtained (step S136). If not all the subroutine information in the subroutine information storage 122 is obtained, the process returns to step S131 and the structure-input-output data relation creator 115 obtains the next subroutine information. If all the subroutine information is obtained, the structure-input-output data relation creator 115 ends the process.

Thus, the structure-input-output data relation creator 115 can associate the computer program call structure with the input-output information by adding the subroutine information stored in the input-output information storage to the corresponding subroutine information in the subroutine information storage 122.

As a subroutine, there are cases where a multiple number of processes included in a computer program are called and cases of where another computer program is called. When there is a mixture of these two cases, sometimes the nesting has a considerable depth. In such a case, levels from the nesting level next to the nesting level from where another computer program is called are omitted and only the input-output information is added to the input-output information of the subroutine information of the computer program that is called. This is a method simplified by omission.

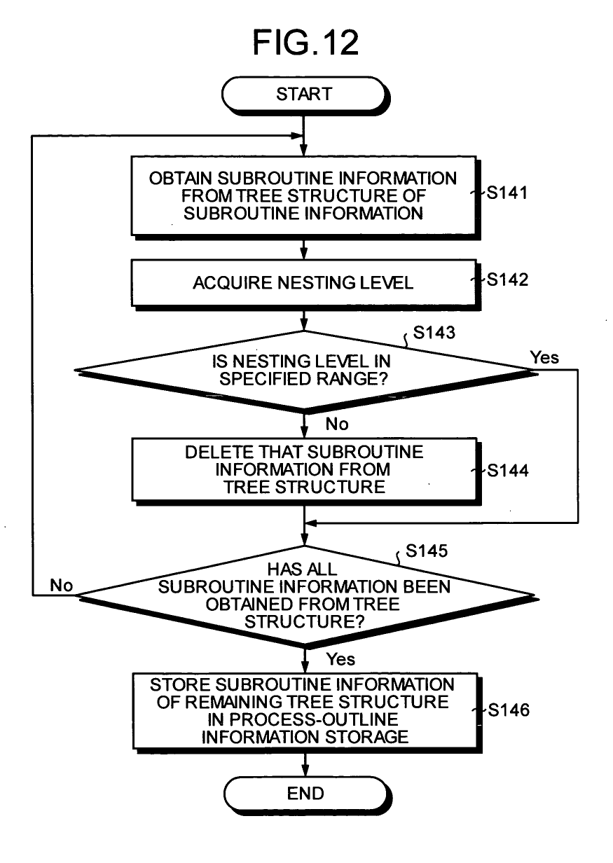

A processing procedure of the process-outline generation by the process-outline creator 116 is described below. FIG. 12 is a flow chart of the processing procedure of the process-outline generation by the process-outline creator. Generation of subroutine information in a range of a specific nesting level as process-outline information from among the process-outline generation by the process-outline creator 116 is described below.

The process-outline creator 116 reads the tree structure of the subroutine information stored in the subroutine information storage 122 and obtains one subroutine information from the tree structure read (step S141). The process-outline creator 116 obtains a nesting level (step S142) and makes a judgment of whether the nesting level obtained is in the specific range (step S143).

If the nesting level is not judged to be in the specific range, the process-outline creator 116 deletes that subroutine information from the tree structure (step S144). The process-outline creator obtains all subroutine information from the tree structure and makes a judgment of whether the nesting level is checked (step S145). If all the subroutine information is not checked, the process returns to step S141 and the process-outline creator 116 checks the next subroutine information. If all the subroutine information is checked, the process-outline creator stores subroutine information of the remaining tree structure in the process-outline information storage 124 (step S146).

Thus, the process-outline creator 116 can generate the process-outline in which the call structure of the computer program is associated with the input-output information the subroutine information in the specified range only from the subroutine information of the tree structure stored in the subroutine information storage 122.

According to the first embodiment, the structure extractor 112 extracts the call structure of the subroutine from the syntax analysis by the syntax-analyzer 111 and the input-output data extractor 114 extracts the input-output information of each subroutine. The structure-input-output data relation creator 115 associates the call structure of the computer program with the input-output information based on the information extracted by the condition branching information extractor 113, the structure extractor 112, and the input-output data extractor 114. The process-outline creator 116 extracts the information in the specified range from the information associated by the structure-input-output data creator 115 and creates the process-outline information. The document creator 117 prepares the computer program specifications based on the process-outline information generated by the process-outline creator 116. As a result, it is easy to understand the process-outline of the computer program.

Moreover, according to the first embodiment, the condition branching information extractor 113 extracts the condition information of the condition branching from the syntax analysis by the syntax analyzer 111. The structure extractor 112 adds the condition information of the condition branching of the subroutine to the subroutine information. As a result, in a case of such conditions, it is easy to understand whether the input output is performed.

In the COLUMN FOR COMMENTS in the computer program specifications in FIG. 8, the user can write any comments. However, the specifications are regenerated, the comments entered by the user are not carried on. It follows that the user must rewrite the comments for the regenerated specifications once again. In a second embodiment, a specifications creator due to which it is not necessary for the user to enter the comments once again when the computer program specifications are generated automatically is described.

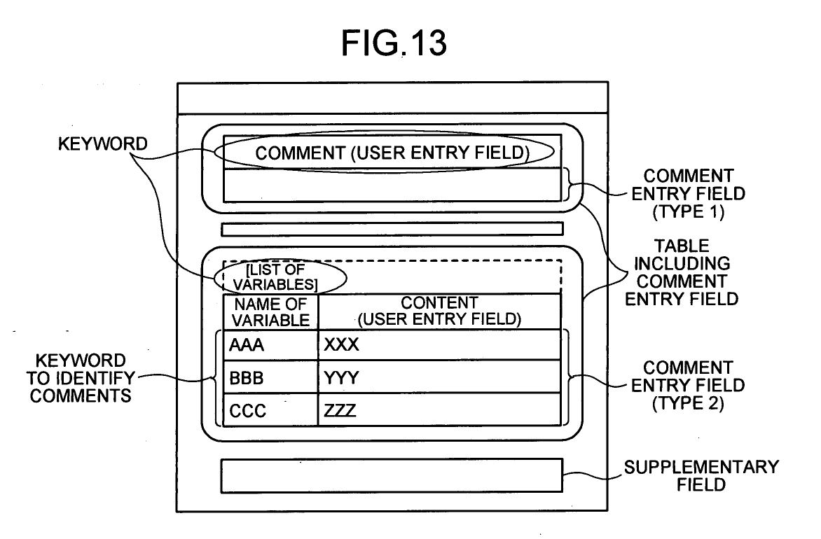

To start with, comment inheritance according to the second embodiment is described below. FIG. 13 is an illustration of the comment inheritance according to the second embodiment. A comment entry field in the computer program specifications that are prepared by a document preparation application.

A comment entry field is prepared by the document preparation application in a tabular format. Each comment entry field is provided with key words like COMMENT (USER ENTRY FIELD), [LIST OF VARIABLES] etc. There are comment entry fields of two types. In one type there is only one entry field (TYPE 1) and in the other there is a plurality of entry fields (TYPE 2).

The specification creator according to the second embodiment reads comments entered by the user in the comment entry field from the computer program specifications and inherits automatically a comment that is read in the same position of the computer program specifications generated.

A supplementary field is provided in the computer program specifications. If a comment entry filed in which the comment is entered is not in the computer program specifications that are regenerated, the comment is entered in the supplementary field.

Thus, the specification creator according to the second embodiment reads the computer program specifications in which the comment is entered and inherits automatically the comment that is read in the same position in the regenerated specifications. As a result, it is possible to inherit important information such as knowledge about business and operational know-how entered by the user as comments between the old and new computer program specifications.

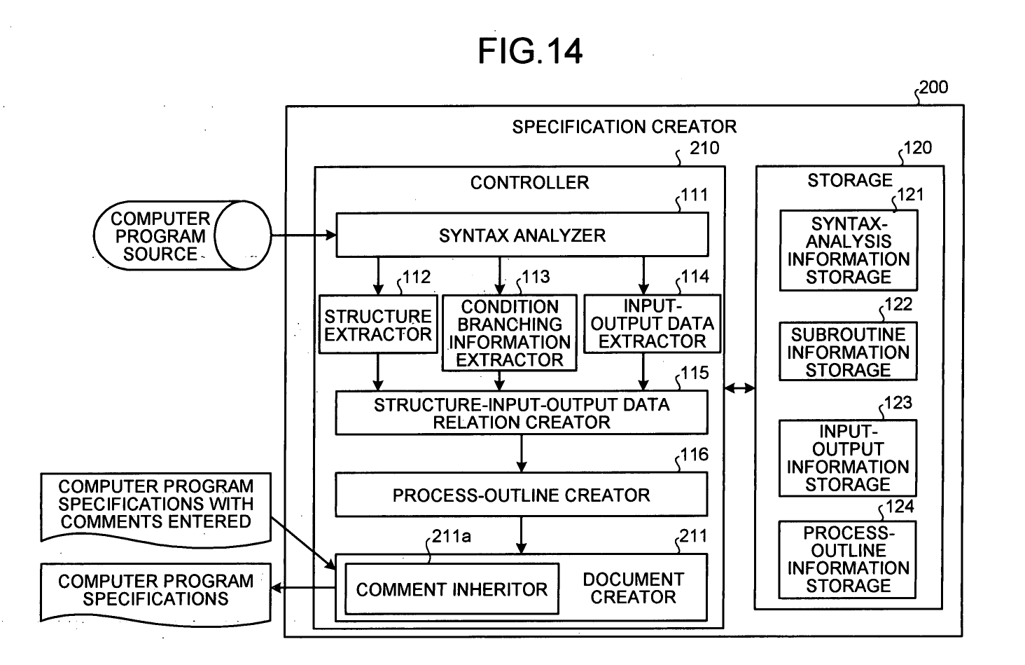

A composition of the computer program specification creator according to the second embodiment is described below. FIG. 14 is a functional block diagram of the specification creator according to the second embodiment. For the sake of convenience, same reference numerals are used for components that perform the same function as the components in FIG. 1 and detailed description of these components is omitted.

A specification creator 200 includes a controller 210 and the storage 120. The storage 120 stores intermediate results etc. of the process performed by the controller 210. The controller 210 includes a document creator 211 in place of the document creator 117 shown in FIG. 1.

A document creator 211, in addition to the functions (functional components) performed by the document creator 117, includes a comment entry contents inheritor 211a. The comment entry contents inheritor 211a reads computer program specifications with comments entered and extracts the comments. The comment entry contents inheritor 211a reflects the comments extracted in the regenerated specifications.

The comment entry contents inheritor 211a reads the computer program specifications with the comments entered and extracts the comments. The comment entry contents inheritor 211a reflects the comments extracted in the regenerated specifications. As a result, the specification creator 200 can inherit the comment entered in the old computer program specifications to the computer program that is generated newly.

A data structure that is used in a comment inheritance by the comment entry contents inheritor 211a is described below. The specification creator 200 associates position information of the comment entry field with a property that is added to the computer program specifications and performs management of other property that includes a list of these properties as parameters, as comment entry field.

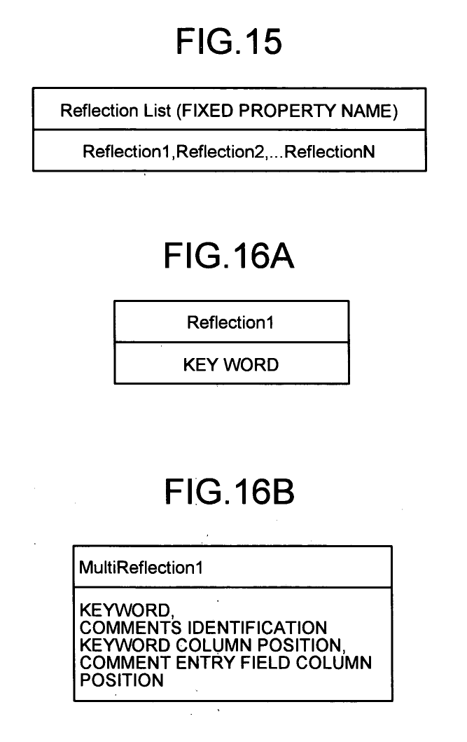

FIG. 15 is an example of a data structure of the property associated with the list of common entry field. A comment entry field list is a property called ReflectionList and parameters of the property is a list that includes properties from Reflection 1 to Reflection N corresponding to each comment entry field.

FIG. 16A is an example of a data structure of a property corresponding to a common entry field. A data structure of Reflection which is an example of a property associated with the comment entry field is shown. A property parameter of Reflection is a key word that identifies the comment entry field.

FIG. 16B is an example of a data structure of a property corresponding to comment entry field when there is a plurality of entry fields. A data structure of MultiReflection which is an example of a property corresponding to the comment entry field when there is a plurality of entry fields, is shown in FIG. 16B. Parameters of property of MultiReflection includes key words that identify the comment entry field, a position of a column of a plurality of comment keywords that identify the entry field, and a position of a column of the comment entry field.

For example, the parameter of the property corresponding to the comment entry field [LIST OF VARIABLES] shown in FIG. 13 becomes [LIST OF PARAMETERS], 1, 2. In other words, a first column of the comment entry field [LIST OF PARAMETERS] is a plurality of comment identification key words that identify each entry field and a second column is a comment that is entered.

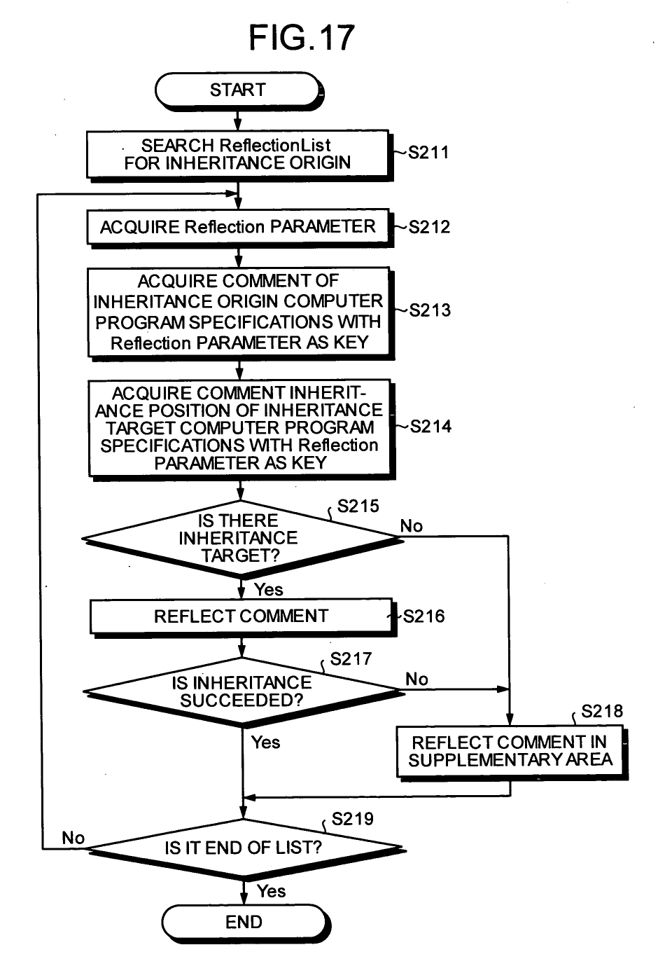

A processing procedure of the comment entry contents inheritor 211a shown in FIG. 14 is described below. FIG. 17 is a flow chart of the processing procedure of the comment entry contents inheritor shown in FIG. 14.

The comment entry contents inheritor 211a searches a ReflectionList of the computer program specifications of an origin of the comment inheritance (step S211) and acquires one Reflection from the ReflectionList (step S212).

The comment entry contents inheritor 211a further acquires a comment inheritance position and a comment of the inheritance origin by using a key word that is a parameter of the Reflection acquired (steps S213 and S214). The comment entry contents inheritor 211a makes a judgment of whether there is a comment inheritance position of computer program specifications of an inheritance target (step S215). If the comment inheritance position is judged to be there, a comment of the program specifications of the inheritance origin is reflected in the program specifications of the inheritance target (step S216).

Further, the comment entry contents inheritor 211a makes a judgment of whether the inheritance of the comment is succeeded (step S217). If the inheritance of the comment is judged to be succeeded, the comment entry contents inheritor 211a reflects the comment in the supplementary field (step S218). The comment entry contents inheritor 211a makes a judgment of whether all Reflection in the ReflectionList are processed (step S219). If not all the Reflections in the ReflectionList are judged to be processed, the process returns to step S212 and the comment entry contents inheritor 211a performs the process of next Reflection. If all the Reflections in the ReflectionList are judged to be processed, the comment entry contents inheritor 211a end the process.

Thus, the comment entry contents inheritor 211a reads the comment from the computer program specifications of the inheritance origin by using the ReflectionList and reflects it to the computer program specifications of the inheritance target. As a result, the comment entry contents inheritor 211a can inherit automatically the comment that is entered in the computer program specifications by the user.

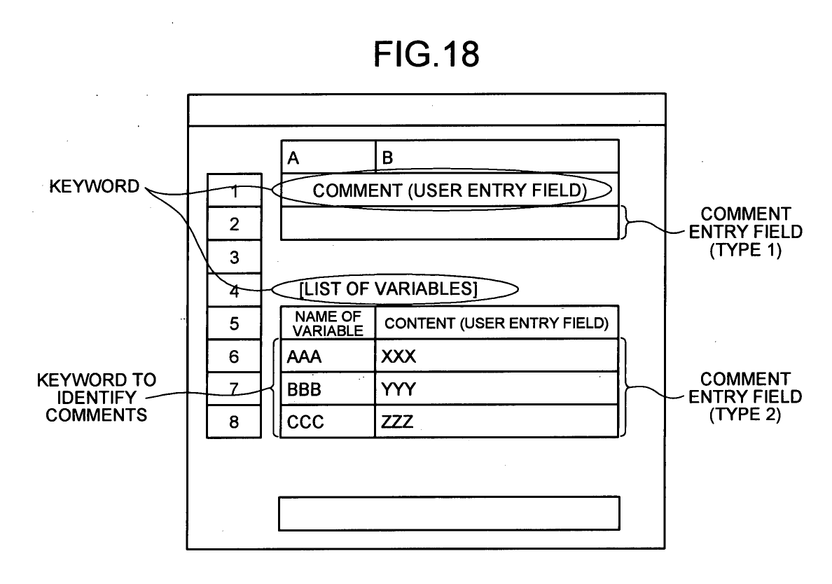

A comment entry field of computer program specifications in other format is described below. To start with, a comment entry field of computer program specifications that uses a spread sheet is described. FIG. 18 is an example of the comment entry field of the computer program specifications using the spread sheet.

When the spread sheet is used, all fields can be specified by rows and column. Therefore, parameters of a property corresponding to the comment entry field are a key word, a row position, and a column position.

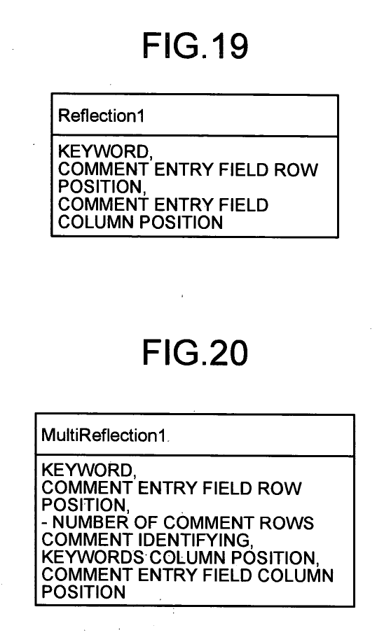

FIG. 19 is an example of a data structure of the property corresponding to the comment entry field of the computer program specifications using a spread sheet. A data structure of Reflection 1 which is an example of a property corresponding to the comment entry field is shown in FIG. 19. Parameters of the property of the Reflection 1 include a key word, a comment entry field row position, and a comment entry field column position.

The comment entry field row position is a relative row position from the key word. For example, parameters of a property corresponding to the comment entry field COMMENT (USER ENTRY FIELD) is COMMENT (USER ENTRY FIELD), 1, A).

FIG. 20 is an example of a data structure of the property corresponding to a comment entry field (when there is a plurality of entry fields) of a computer program using a spread sheet. A data structure of MultiReflection 1 which is an example of a property corresponding to the comment entry field, when there is a plurality of entry fields is shown in FIG. 20. Parameters of the property of the MultiReflection 1 includes a key word, a comment entry field row position, a number of rows in a column, a comments identification key word column position, and a comment entry field column position.

The comment entry field row position is a relative row position from the key word. For example, parameters of a property corresponding to the comment entry field [LIST OF VARIABLES] is [LIST OF VARIABLES], 2, 1, A, B.

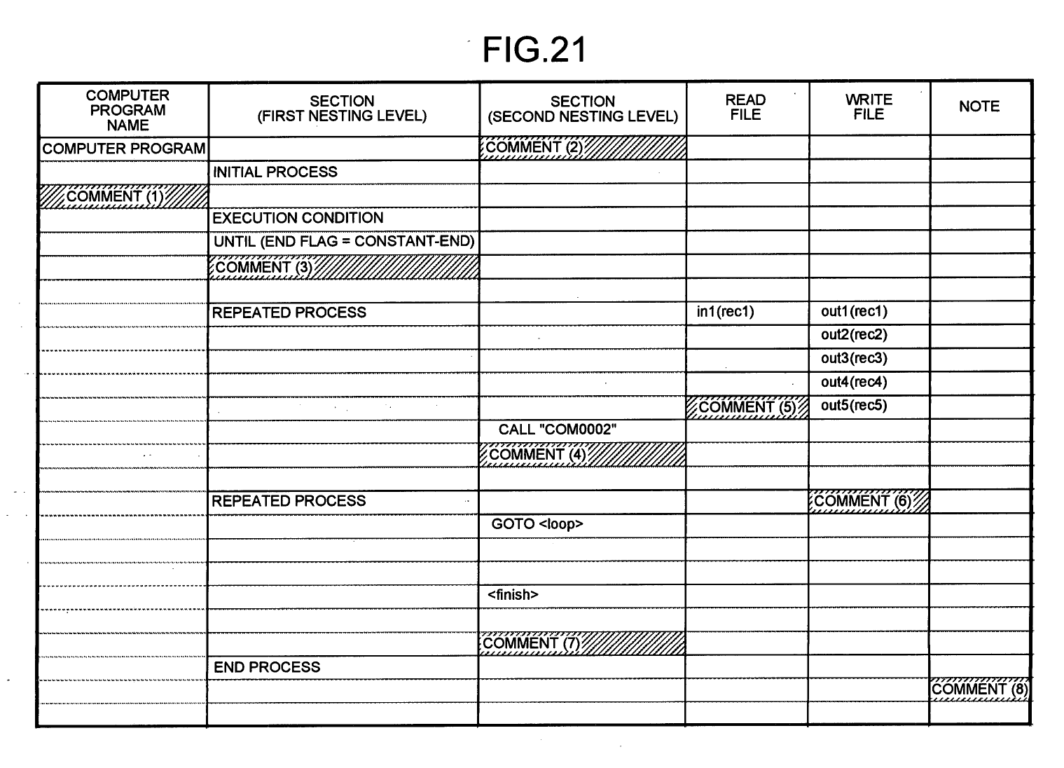

FIG. 21 is an illustration of a comment entry field in a process structural diagram. The process structural diagram is described below in detail. A comment (n) is in the comment entry field.

In the process structural diagram, to distinguish between a cell which includes a content generated automatically and a cell in which the user can enter a comment, writing is inhibited in the cell that includes the content generated automatically and different colors are used for these two types of cells. To have a cell in which a comment can be entered, in each section, an empty cell is inserted without fail in a hatched area of each section while generating the process structural diagram.

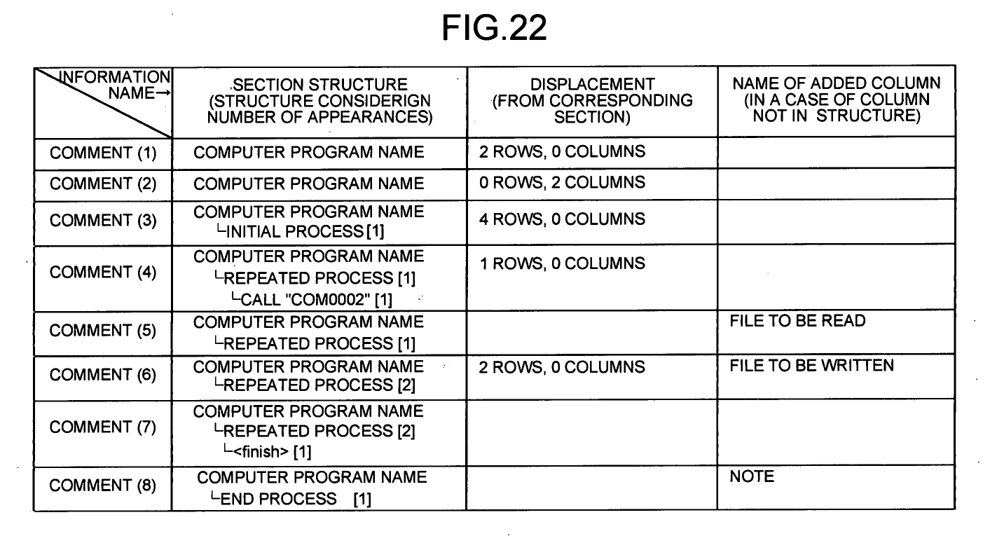

FIG. 22 is an example of position information data of each comment entry field in the process structural diagram shown in FIG. 21. In this example, the position information data includes a comment entry field corresponding to a section structure, a relative displacement from the corresponding section, and a name of an added column.

For example, COLUMN (1) corresponds to a section of COMPUTER PROGRAM NAME and its position is two rows and zero columns from a cell COMPUTER PROGRAM NAME. COMMENT (4) corresponds to COMPUTER PROGRAM NAME—REPEATED PROCESS [1]—CALL “COM0002” and its position is one row and zero columns from CALL “COM0002”.

The specification creator 200 performs management of the comment entry fields of the process structural diagram by using the position information data. Therefore, it is possible to inherit automatically the user's comment that is entered in the process structural diagram.

When there is a section structure corresponding to the process structural diagram of the inheritance target but there is no corresponding cell or a column, the specification creator 200 enters the comment in a space for note. Whereas, when there is no section structure corresponding to the process structural diagram of the inheritance target, the specification creator 200 enters the comment and the position information of the comment entry field in a supplementary space.

In a case of a work sheet with a page control such as a screen transition diagram that is described in the latter part, since the position information changes at every output, the method mentioned here cannot be used. Therefore, a particular sheet is used as user's entry area and whole comment written in the user's entry sheet is inherited.

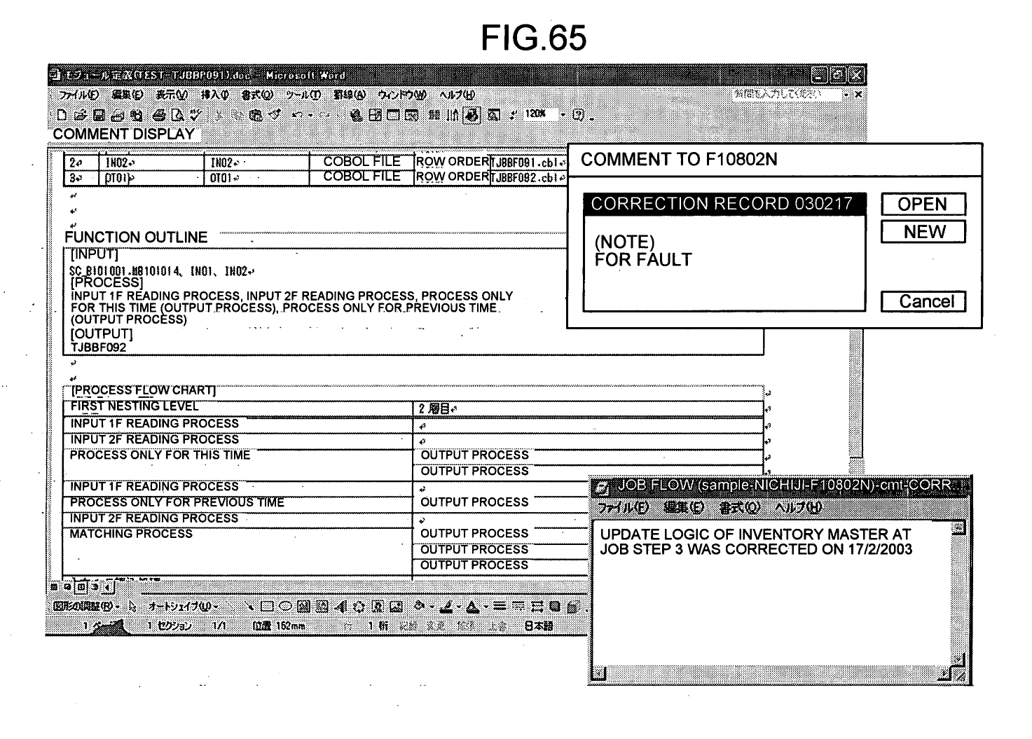

FIG. 65 is an example of comment inheritance in which a space for user's entry is not allocated. A case where the space for the user's entry is not provided and an interface for entry of comment is made thereby allowing the user to make an entry freely is shown in FIG. 65.

The user enters the comment by using the interface (like a comment entry button) that is provided in advance. The comment entered is managed as a different document and is associated with the specifications. A document naming rule for example is determined as a method of associating. An arrangement is made so that a comment document that is added to a specification called XXX becomes XXX-COMMENT 1 and the specification becomes unique.

Thus, even if the specifications are regenerated, the XXX is overwritten but XXX-COMMENT 1 is not overwritten. Therefore, the comment entered by the user is in continuously held. For referring to the previous comment from the specifications regenerated, the comment is extracted from the associated document and displayed by using an interface that displays the comment.

For example, in FIG. 65, CORRECTION RECORD 030217 and NOTE CORRESPONDING TO OBSTACLE are comments entered in the specifications F10802N and CORRECTION RECORD 030217 includes UPDATE LOGIC OF INVENTORY MASTER AT JOB STEP 3 WAS CORRECTED ON Feb. 17, 2003 as content.

Thus, according to second embodiment, the comment entry content inheritor 211a in the document creator 211 obtains a comment from the computer program specifications with a comment entered and reflects in a position corresponding to computer program specifications that are regenerated. As a result, it is possible to inherit automatically the comment that is added to the computer program specifications by the user. The automatic inheritance of the comment enables to reduce considerably the man-hours required for transfer of duties by writing the knowledge of the predecessor as a comment in computer program specifications at the time of shift change of a person in charge of maintenance.

As it is described in the first embodiment, the basic process structure of a computer program can be understood by a process-outline in which the call structure of the subroutine is associated with the input-output information. However, to understand the computer program, understanding of process of the computer program in addition to the basic process structure in necessary to understand the computer program. In the third embodiment, a specification creator that extracts an outline of the computer program process from the computer program and generates the outline extracted as computer program-outline is described.

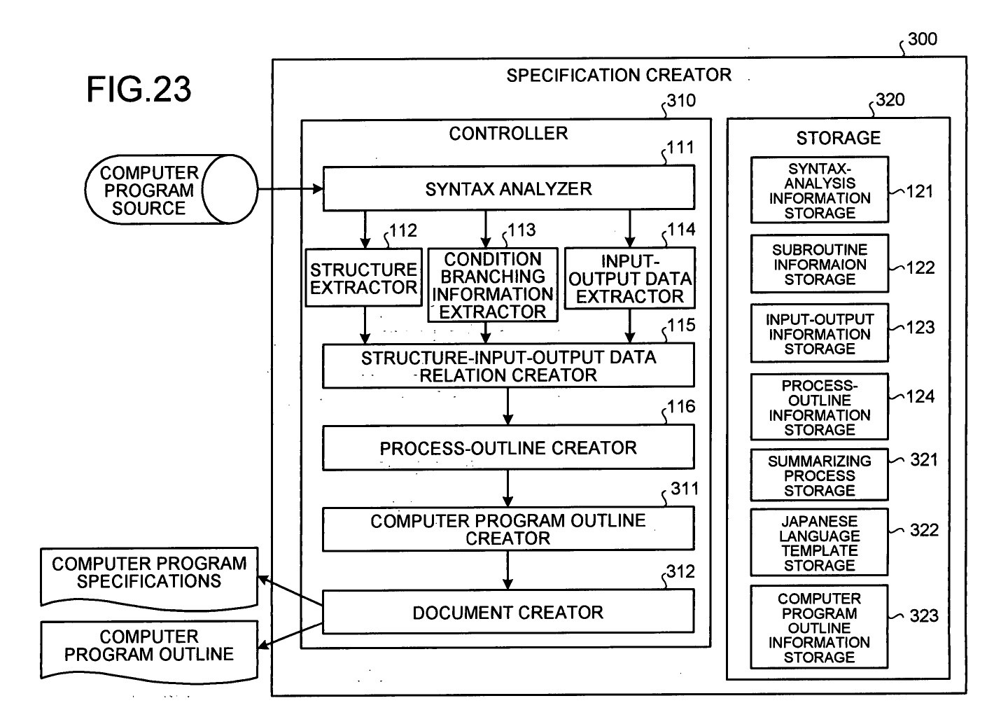

To start with, a composition of the specification creator according to the third embodiment is described. FIG. 23 is a functional block diagram of the specification creator. For the sake of convenience, same reference numerals are used for components that perform the same function as the components in FIG. 1 and detailed description of these components is omitted.

A specification creator 300 includes a controller 310 and a storage 320. The storage 320 stores intermediate results etc. of the process performed by the controller 310. The controller 310 includes a computer program-outline creator 311 in addition to a functional components included in the controller 110 in FIG. 1. The controller 310 further includes a document creator 312 instead of the document creator 117.

The storage 320, in addition to the storage included in the storage 120 in FIG. 1, includes a summarizing process storage 321, a Japanese language template storage 322, and a computer program-outline information storage 323.

The computer program-outline creator 311 generates outline of a computer program process as computer program-outline information. The computer program-outline information storage stores the computer program-outline information generated.

The document creator 312 generates computer program specifications by using the process-outline information and generates computer program-outline by using the computer program-outline information stored in the computer program-outline information storage 323.

The summarizing process storage 321 stores a summarizing process that is performed to generate the computer program-outline information. The Japanese language template storage 322 stores a Japanese language template to generate the computer program-outline in Japanese language by the computer program-outline creator 311.

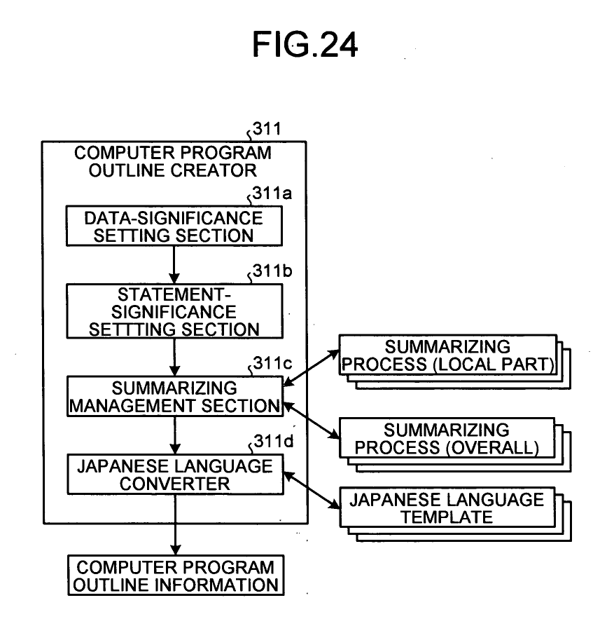

FIG. 24 is a functional block diagram of the computer program-outline creator 311. The computer program-outline creator 311 includes a data significance-level setting section 311a, a statement significance-level setting section 311b, a summarizing management section 311c, and a Japanese language converter 311d.

The data significance-level setting section 311a converts the syntax analysis information stored in the syntax-analysis information storage 121 to computer program intermediate information in XML format and assigns significance level to data that is included in the computer program intermediate information.

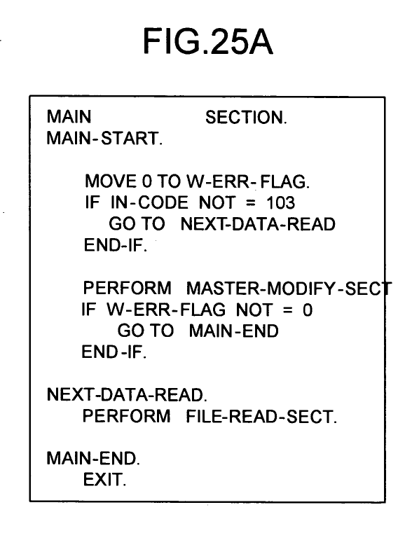

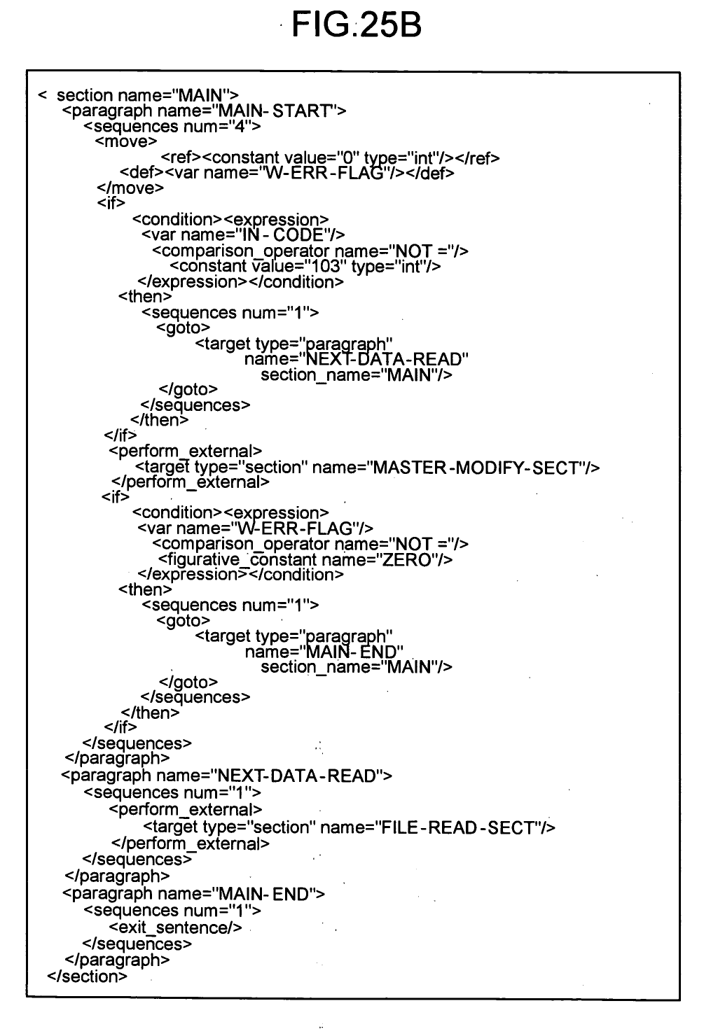

FIGS. 25A and 25B illustrate the computer program intermediate information. FIG. 25A is an example of a computer program source and FIG. 25B is computer program intermediate information generated from the computer program source in FIG. 25A.

As shown in FIG. 25B, basically one tag corresponds to one statement in the computer program. Parameters are included in a statement and are entered by using child tags.

For example a statement MOVE 0 TO W-ERR-FLAG is converted to computer program intermediate information

<move>

<ref> <constant value=“0” type=“int”/> </ref>
<def> <var name=“W-ERR-FLAG” /> </def>

</move>.

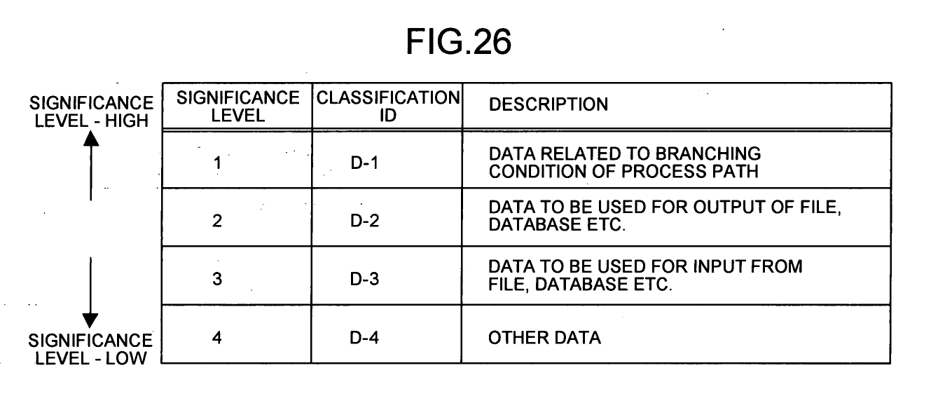

FIG. 26 is an example of classification of significance levels of data. As shown in FIG. 26, the data significance-level setting section 311a classifies DATA RELATED TO BRANCHING CONDITION OF PROCESS PATH as data having the highest significance level 1 and assigns classification ID D-1. The data significance-level setting section 311a classifies DATA TO BE USED FOR OUTPUT OF FILES, DATABASE ETC. as data having significance level 2 and assigns classification ID D-2.

The data significance-level setting section 311a classifies DATA TO BE USED FOR INPUT FROM FILES, DATABASE ETC. as data having significance level 3 and assigns classification ID D-3. The data significance-level setting section 311a classifies OTHER DATA as data having significance level 4 and assigns classification ID D-4.

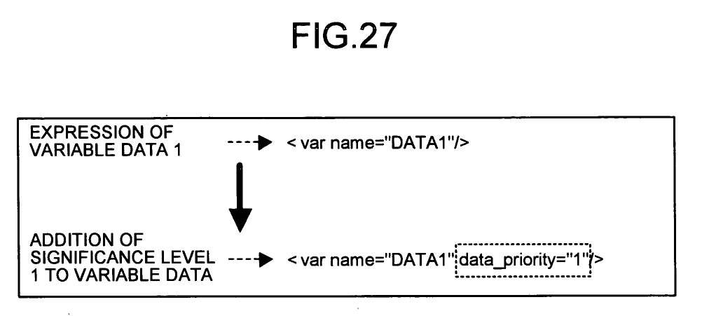

The data significance-level setting section 311a adds significance level of data in a form of attribute to tag for variables of the computer program intermediate information to all parameters in the computer program. FIG. 27 is an example of the significance level that is added to a tag for variables of the computer program intermediate information.

As shown in FIG. 27, parameter DATA 1 is expressed as <var name=“DATA 1”/> in the computer program intermediate information. When the significance level 1 is added, the parameter DATA 1 is expressed as <var name=“DATA 1” data_priority=“1”/>.

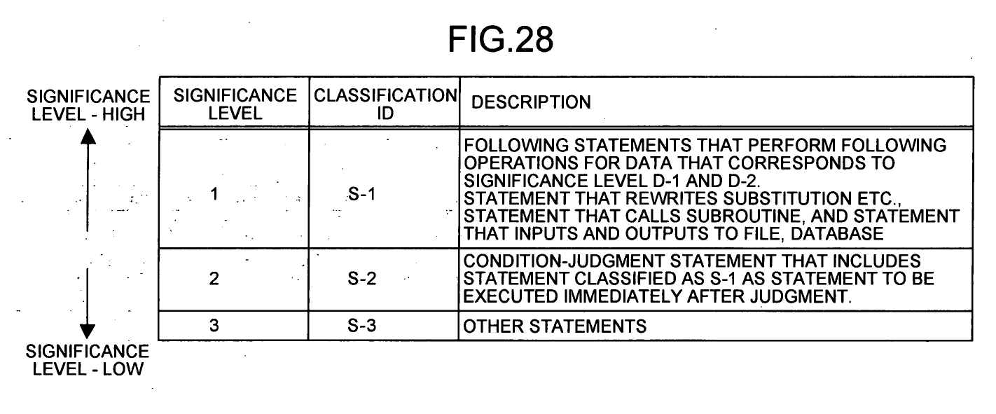

The statement significance level 311b adds significance level of statement to the computer program intermediate information to which the significance level of data is added. FIG. 28 is an example of classification of significance levels of statements.

As shown in FIG. 28, the statement significance-level setting section 311b classifies FOLLOWING STATEMENTS THAT PERFORM FOLLOWING OPERATIONS FOR DATA THAT CORRESPONDS TO SIGNIFICANCE LEVEL D-1 AND D-2, STATEMENT THAT REWRITES SUBSTITUTION ETC., STATEMENT THAT CALLS SUBROUTINE, AND STATEMENT THAT INPUTS AND OUTPUTS TO FILE, DATABASE as data having the highest significance level 1 and assigns classification ID S-1. The statement significance-level setting section 311b classifies among condition judgment statements a CONDITION JUDGMENT STATEMENT THAT INCLUDES STATEMENT CLASSIFIED AS S-1 AS STATEMENT TO BE EXECUTED IMMEDIATELY AFTER JUDGMENT as data having significance level 2 and assigns ID S-2. The statement significance-level setting section 311b classifies OTHER STATEMENTS as data having significance level 3 and assigns ID S-3.

Further, the statement significance-level setting section 311b analyzes significance levels of data and tag of statement that is not entered in the computer program intermediate information, and determines significance level of each statement. The statement significance-level setting section 311b adds the significance level of statement as an attribute of a tag.

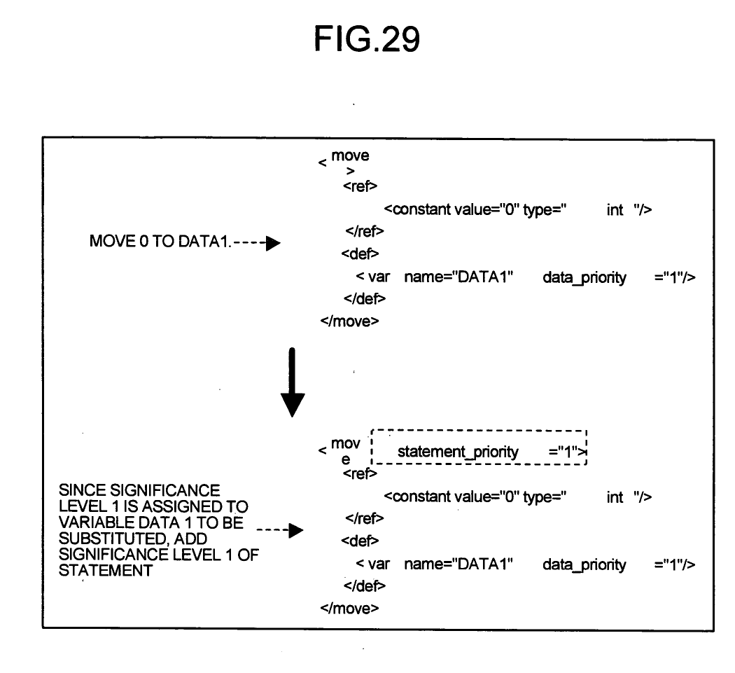

FIG. 29 is an example of a significance level that is added to a tag of statement of the computer program intermediate information. As shown in FIG. 29, for a statement MOVE 0 TO DATA 1, since significance level 1 is added to a variable DATA 1, the significance level of the statement is added as <move statement_priority=“1”>.

Thus, the statement significance-level setting section 311b generates computer program intermediate information to which the significance level of statement is added. The classification of the significance level of data and statement may be changed or subdivided by the processing of the summarizing management section 311c according to requirement.

The summarizing management section 311c performs various summarizing processes on the computer program intermediate information to which the significance level of data and statement is added. The summarizing process by the summarizing management section 311c includes summarizing process of local part of the computer program and summarizing process of overall process flow of the computer program.

In the local summarizing process, a pattern of a part of the computer program is extracted and a predetermined process of the pattern extracted is performed. For example, if a substitution process of a data item is entered continuously is the computer program and if the data item belongs to a certain same group item, the substitution process is grouped as one substitution by using the group item.

Moreover, the local summarizing process includes deletion of a statement that is not important and leaving a high level subroutine in a call structure by using the subroutine nesting level extracted by the structure extractor 112.

In the overall summarizing process, for example, a computer program executed in the form of a loop formed by a jump statement is detected and is replaced by an expression that the computer program is in a loop form.

Concretely, the summarizing management section 311c, in the beginning reads a summarizing processing computer program that performs summarizing processing and performs summarizing by executing the summarizing processing computer program read.

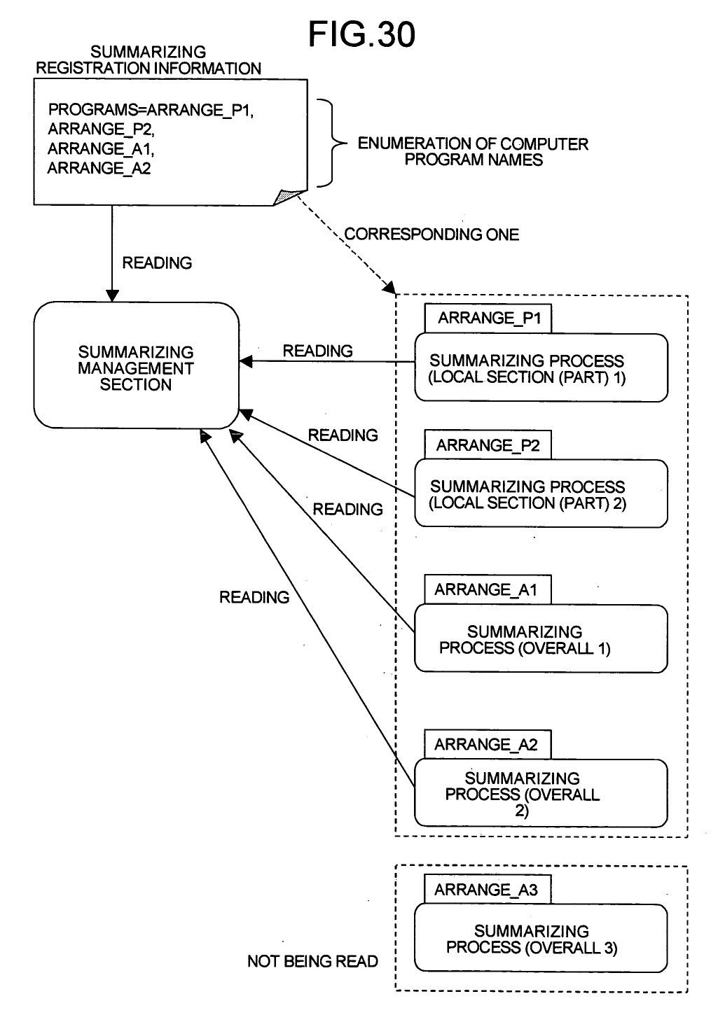

FIG. 30 is an illustration of an initial operation of the summarizing management section 311c. As shown in FIG. 30, the summarizing management section 311c prepares a computer program name of the summarizing processing computer program as summarizing registration information and reads in the beginning the summarizing processing computer program registered in the registration information.

In FIG. 30, ARRANGE_P1, ARRANGE_P2, ARRANGE_A1, and ARRANGE_A2 registered as computer program names to be read. The summarizing processing computer programs ARRANGE_P1, ARRANGE_P2, ARRANGE_A1, and ARRANGE_A2 are read and executed.

ARRANGE_P1 and ARRANGE_P2 local summarizing processing computer programs and ARRANGE_A1 and ARRANGE_A2 are computer programs that perform local summarizing processing. The summarizing processing to be performed can be changed easily by replacing the computer program names that are registered in the registration information.

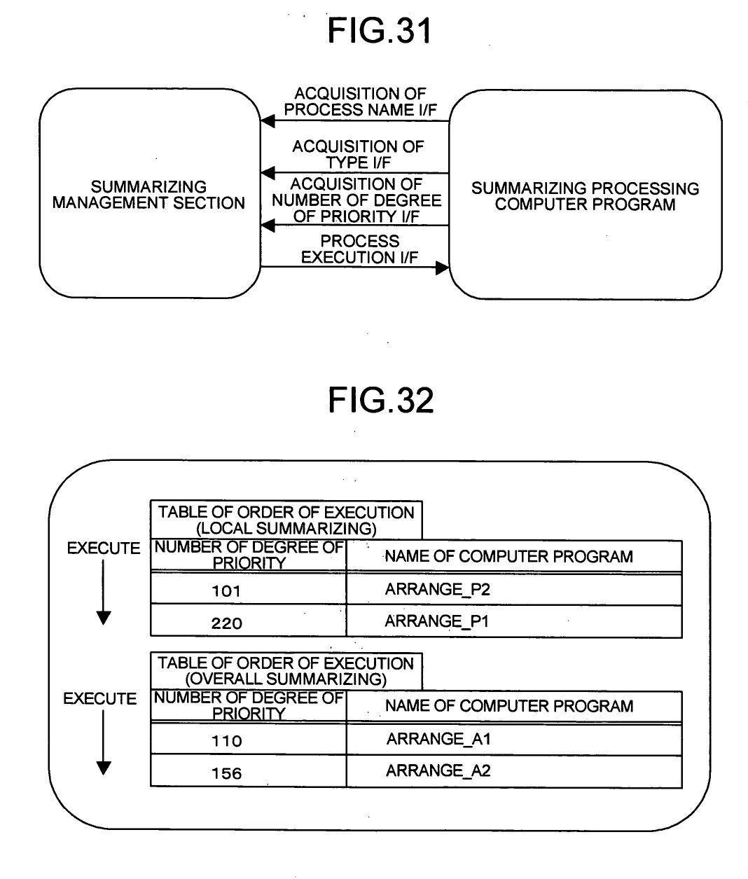

FIG. 31 is a diagram of interfaces (I/F) between the summarizing management section 311c and the summarizing processing computer program. As shown in FIG. 31, there are four interfaces viz. acquisition of process name I/F, acquisition of type I/F, acquisition of number of degree of priority I/F, and process execution I/F.

The acquisition of process name I/f informs the name of a summarizing process that is performed by the summarizing processing computer program (for example “summarizing processing of group item) to the summarizing management section 311c. The acquisition of type I/F informs the type of a summarizing process (for example local, overall) to the summarizing management section 311c.

The acquisition of number of degree of priority I/F informs the number of degree of priority (for example 10, 104) to the summarizing management section 311c and the process execution I/F is used during execution of the summarizing processing computer program by the summarizing management section 311c.

Parameters that are passed during execution of the summarizing processing program by the summarizing management section 311c are mainly computer program intermediate information. If any structure information extracted by the structure extractor 112 in the summarizing processing is required, the required information is passed as parameters.

The number of degree of priority is a relative number for determining a processing order of the summarizing processing computer program. In this case, the summarizing processing computer program is executed in ascending order of the number of degree of priority. The summarizing management section 311c determines and maintains the order of execution of the summarizing processing computer program by using the information acquired via the interfaces.

FIG. 32 is an example of an order of execution maintained of the summarizing processing computer program. In FIG. 32, a summarizing processing computer program that performs the local summarizing processing is executed first and a summarizing processing computer program that performs the overall summarizing processing is executed later. An order maintained of execution in the ascending order of the number of degree of priority in respective processes is shown.

Name, type, and number of degree of priority of the summarizing process are defined by a developer while developing the summarizing processing computer program. When the number of degree of priority is same, the order of execution is maintained in an order in which the information is registered in the summarizing registration information. The summarizing management section 311c inputs computer program intermediate information to which the significance level of data and statement is added. The summarizing management section 311c executes the summarizing processing computer program according to the order of execution of the summarizing processing computer program maintained.

The summarizing management section 311c provides the computer program intermediate information as input to the summarizing processing computer program. Each summarizing processing computer program edits the computer program intermediate information. The computer program intermediate information edited becomes input to a summarizing processing computer program that is executed next.

Thus, the computer program intermediate information is edited by all summarizing processing computer programs registered. Among the summarizing processing computer programs, there are programs that extract from the computer program intermediate information a pattern of a computer program structure that can be processed by that computer program. If the pattern cannot be extracted, the computer program does not perform that summarizing process and the execution if passed to the next summarizing processing computer program. When the summarizing management section 311c ends execution of all summarizing processing computer programs, it passes the computer program intermediate information edited to the Japanese language converter 311d.

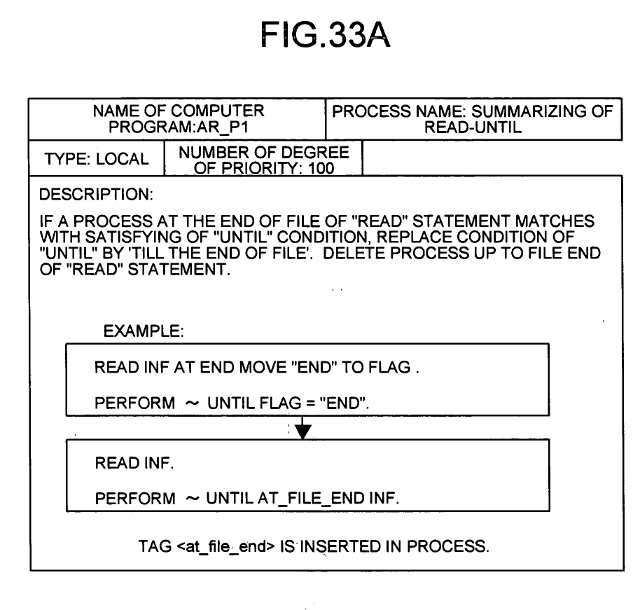

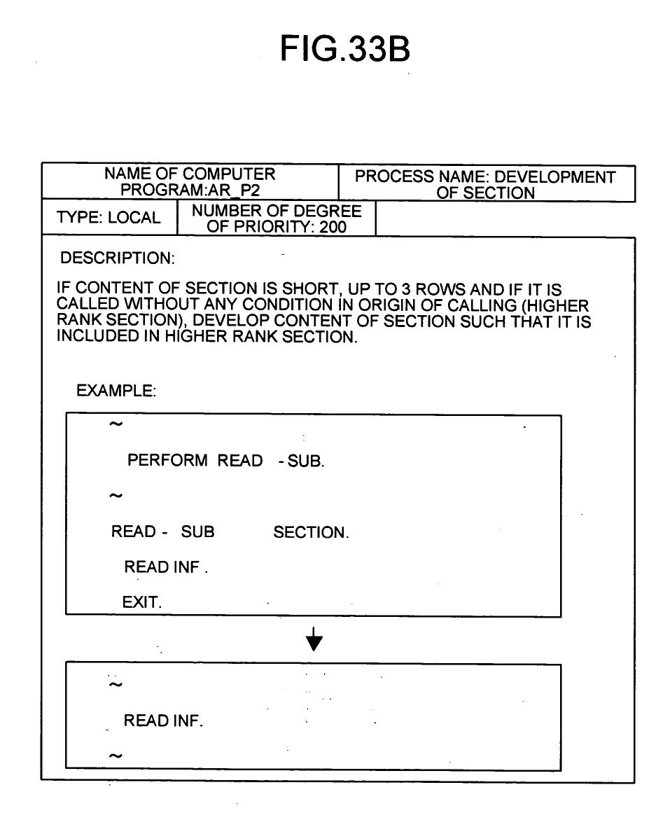

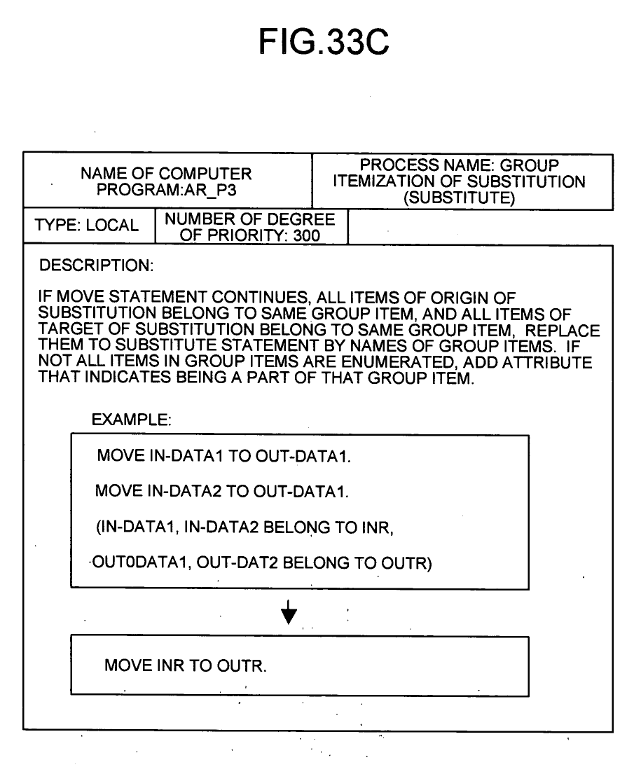

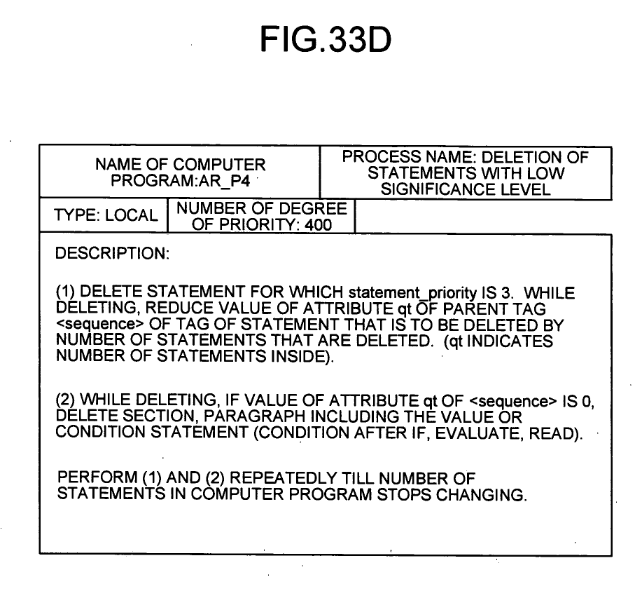

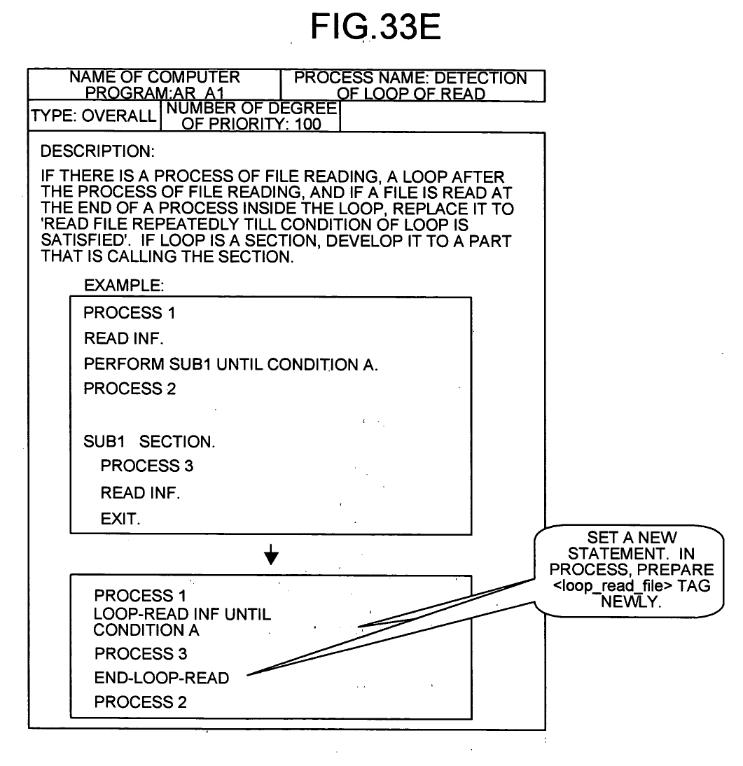

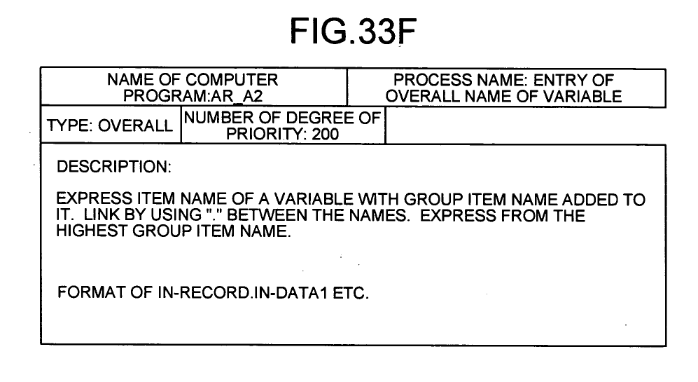

FIGS. 33A to 33F are rule examples of summarizing processing that is performed by the summarizing processing computer program. FIGS. 33A to 33D are rule examples of local summarizing processing and FIGS. 33E and 33F are rule examples of overall summarizing processing.

FIG. 33A depicts following rule of the summarizing processing: “IF A PROCESS AT THE END OF FILE OF READ STATEMENT MATCHES WITH SATISFYING UNTIL CONDITION, REPLACE CONDITION OF UNTIL BY ‘TILL THE END OF FILE’. DELETE PROCESS UPTO FILE END OR READ STATEMENT.”

FIG. 33B depicts following rule of the summarizing processing: “IF CONTENT OF SECTION IS SHORT, UP TO 3 ROWS AND IF IT IS CALLED WITHOUT ANY CONDITION IN ORIGIN OF CALLING (HIGHER RANK SECTION), DEVELOP CONTENT OF SECTION SUCH THAT IT IS INCLUDED IN THE HIGHER RANK SECTION.”

FIG. 33C depicts following rule of the summarizing processing: “IF MOVE STATEMENT CONTINUES, IF ALL ITEMS OF ORIGIN OF SUBSTITUTION BELONG TO SAME GROUP ITEM, AND IF ALL ITEMS OF TARGET OF SUBSTITUTION BELONG TO SAME GROUP ITEM, REPLACE THEM TO SUBSTITUTE STATEMENT BY NAMES OF GROUP ITEMS. IF NOT ALL ITEMS IN GROUP ITEMS ARE ENUMERATED, ADD ATTRIBUTE THAT INDICATES BEING A PART OF THAT GROUP ITEM.”

FIG. 33D depicts following rule of the summarizing processing: “(1) DELETE STATEMENT FOR WHICH statement_priority IS 3. WHILE DELETING, REDUCE VALUE OF ATTRIBUTE qt OF PARENT TAG <sequence> OF TAG OF STATEMENT THAT IS TO BE DELETED BY NUMBER OF STATEMENTS THAT ARE DELETED. (qt INDICATES NUMBER OF STATEMENTS INSIDE. (2) WHILE DELETING, IF VALUE OF ATTRIBUTE qt OF <sequence> IS 0, DELETE SECTION, PARAGRAPH INCLUDING THE VALUE OR CONDITION STATEMENT (CONDITION AFTER IF, EVALUEATE, READ). PERFORM (1) AND (2) REPEATEDLY TILL NUMBER OF STATEMENTS IN COMPUTER PROGRAM STOP CHANGING.”

FIG. 33E depicts following rule of the summarizing processing: “IF THERE IS A PROCESS OF FILE READING AND A LOOP AFTER THE PROCESS OF FILE READING, AND IF A FILE IS READ AT THE END OF A PROCESS INSIDE THE LOOP, REPLACE IT TO ‘READ FILE REPEATEDLY TILL CONDITION OF LOOP IS SATISFIED’. IF LOOP IS A SECTION, DEVELOP IT TO A PART THAT IS CALLING THE SECTION.”

FIG. 33F depicts following rule of the summarizing processing: “EXPRESS ITEM NAME OF A VARIABLE WITH GROUP ITEM NAME ADDET TO IT. LINK BY USING ‘.’ BETWEEN THE NAMES. EXPRESS FROM THE HIGHEST GROUP ITEM NAME. FOR EXAMPLE FORMAT OF IN-RECORD.IN-DATA 1 ETC.”

The Japanese language converter 311d receives the computer program intermediate information that is edited in the summarizing processing and generates Japanese language information by associating with a Japanese language template to which each tag corresponds. The Japanese language information that is generated by the Japanese language converter is stored in the computer program-outline storage 323 and is entered in the program-outline by the document creator 312.

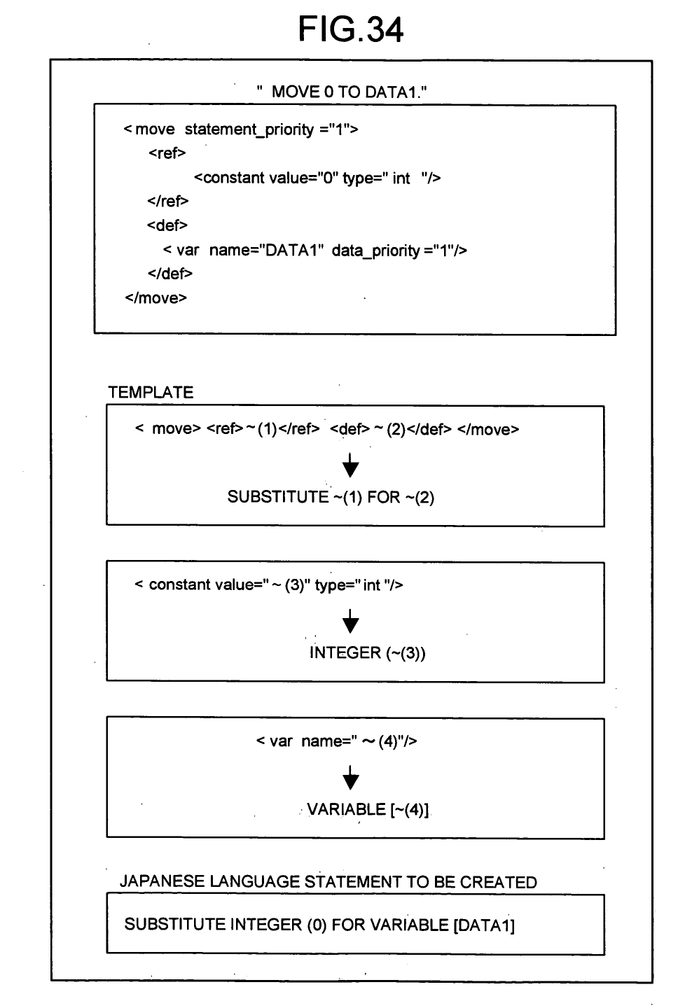

FIG. 34 is an illustration of processing by the Japanese language converter. This is an example in which MOVE statement MOVE 0 TO DATA 1 is converted to Japanese language information SUBSTITUTE INTEGER (0) FOR VARIABLE [DATA 1].

In this case, the Japanese language converter 311d converts by using the following three Japanese language templates,
1) <move><ref>˜(1)</ref><def>˜(2)</def></move>→SUBSTITUTE˜(1)FOR˜(2),
2) <constant value=“˜(3)” type=“int”/>→INTEGER (˜(3)),
3) <var name=“˜(4)”/>→VARIABLE[˜(4)].

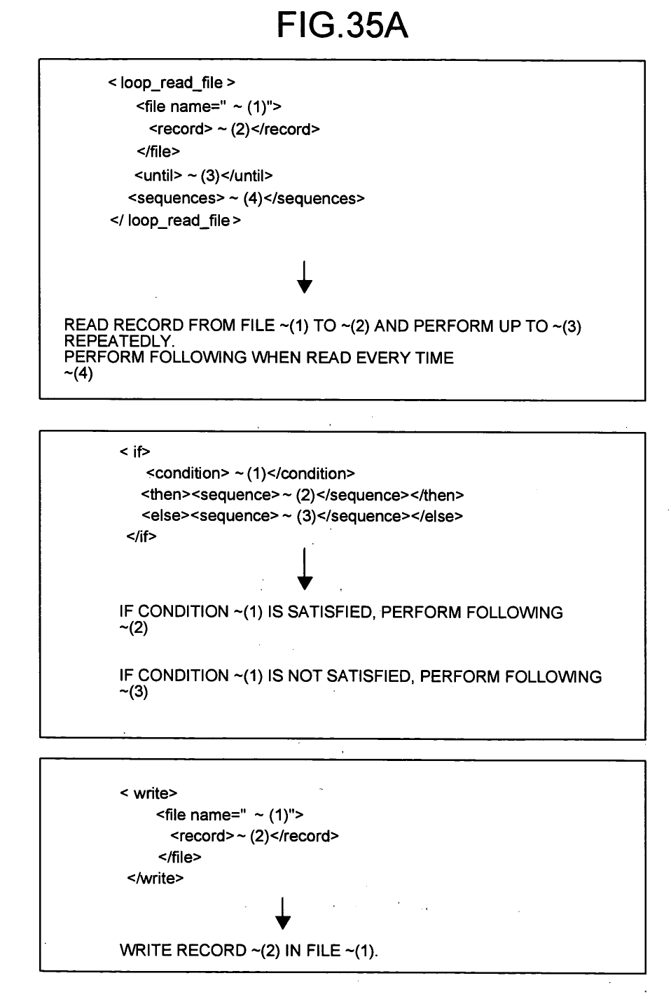

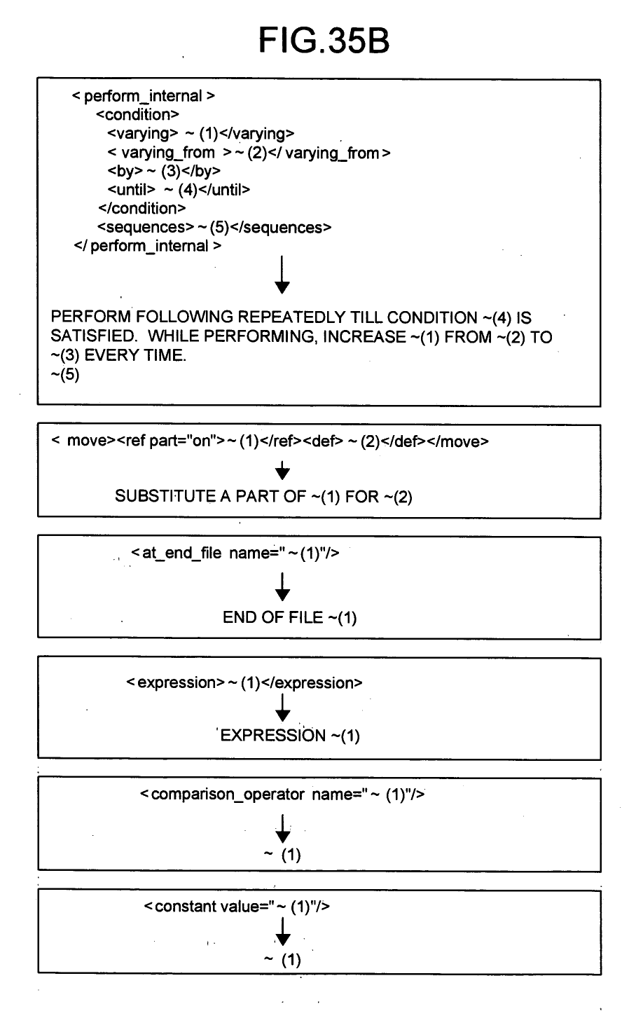

FIGS. 35A and 35B are other examples of Japanese template.

An example of the computer program-outline generated by the computer program-outline creator 311 is described below. The computer program-outline creator 311 converts syntax analysis information of a computer program sample shown in the diagram to the computer program intermediate information and adds significance level to data and statements.

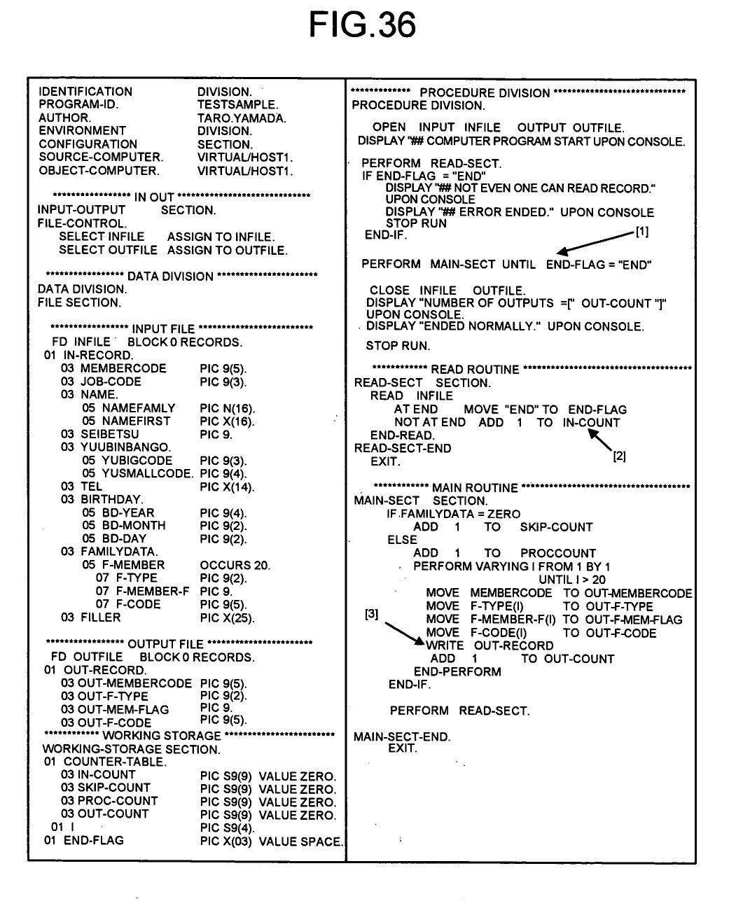

For example, variable END-FLAG shown in [1] in FIG. 36 is an end condition of a section repetition process. Since the variable END-FLAG is a branch, the significance level is 1. Since variable IN-COUNT shown in [2] in FIG. 36 does not belong to classification from D-1 to D-3, the significance level is 4. Since WRITE statement shown in [3] in FIG. 36 is related to input-output of a file, the significance level is 1.

The summarizing management section 311c in the computer program-outline creator 311 performs summarizing processing by applying the rules of summarizing processing depicted in FIGS. 35A to 35F to the computer program intermediate information in which the significance level is added to the data and statements.

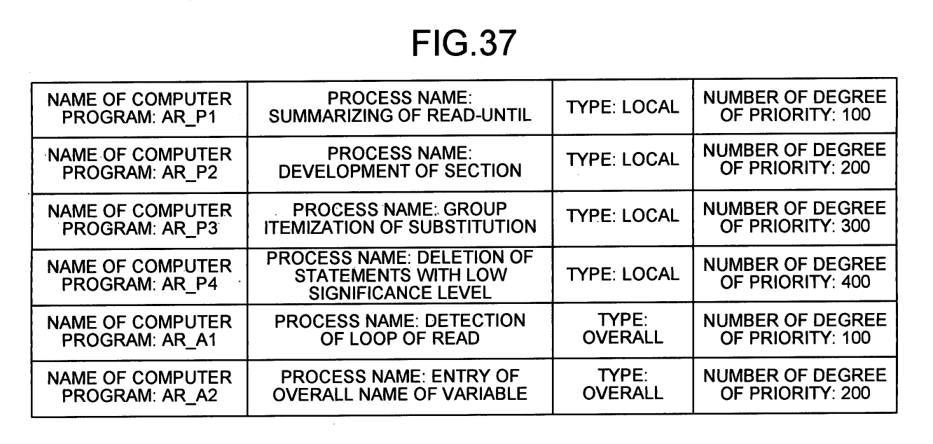

FIG. 37 is a list of summarizing processing computer programs that are used by the summarizing management section 311c. The summarizing management section 311c acquires information shown in FIG. 37 from the summarizing processing computer program by using the interfaces shown in FIG. 31.

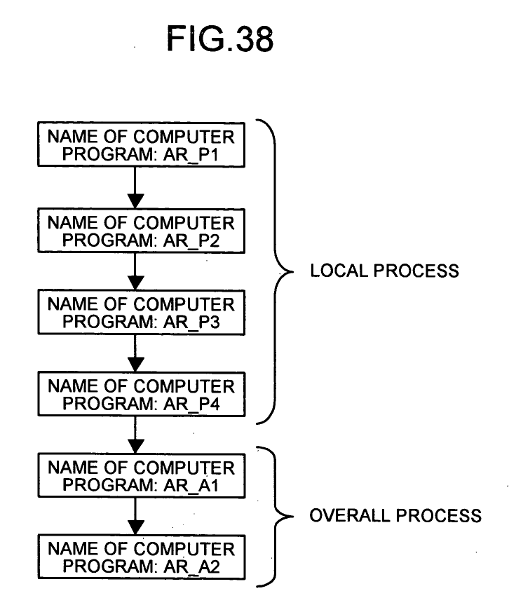

FIG. 38 is an illustration of an order of execution of the summarizing processing computer program. The summarizing management section 311c, based on the list of summarizing processing computer programs, executes the summarizing processing computer program in the order of execution shown in FIG. 38.

In other words, the summarizing management section 311c executes the computer programs in order of AR_P1, AR_P2, AR_P3, and AR_P4 as a local process and then-executes the computer programs AR_A1 and AR_A2 as an overall process.

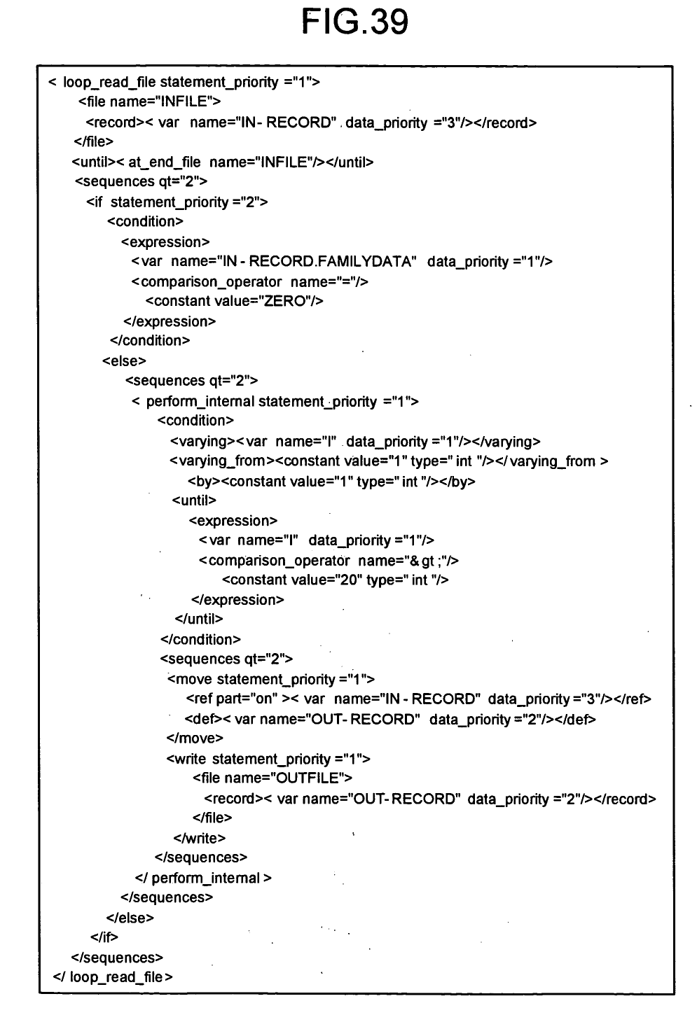

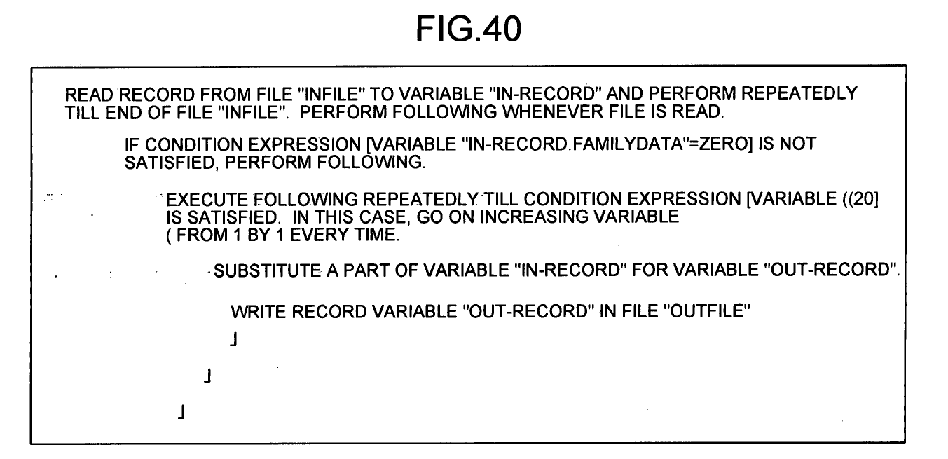

FIG. 39 is computer program intermediate information at the end of the summarizing processing. The Japanese language converter 311d generates Japanese language information shown in FIG. 40 by applying the Japanese language templates shown in FIGS. 34, 35A, and 35B to the computer program intermediate information shown in FIG. 39.

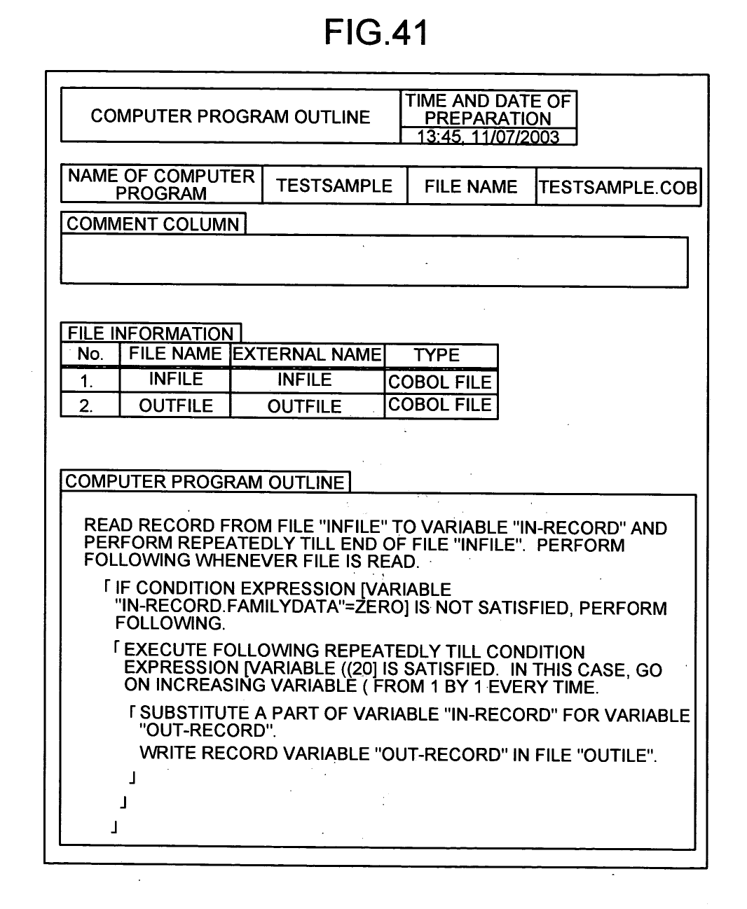

The document creator 312 generates computer program-outline shown in FIG. 41 by using the Japanese language information shown in FIG. 40.

Thus, according to the third embodiment, the computer program-outline creator 311 converts the syntax analysis information generated by the syntax-analyzer 111 to the computer program intermediate information. The computer outline creator 311 generates computer program-outline from the computer program intermediate information by using the summarizing processing computer program stored in the summarizing process storage 321 and the Japanese language templates stored in the Japanese language template storage 322. This facilitates understanding of the processing of the computer program and saves time taken for understanding.

The specification creator that generates the process-outline as specifications of the computer program by analyzing a computer program is described in the first, second, and the third embodiments. However, in many cases in a batch processing system, a predetermined process is performed by executing a plurality of computer program in a proper order.

In such a batch processing system where the computer programs are executed, it is important to understand not only the process-outline of each process but also the process-outline of the overall batch process.

A specification creator that generates specifications by extracting the process-outline of the overall batch processing is described in a fourth embodiment. Concretely, a specification creator according to the fourth embodiment extracts input data and output data in the overall batch process, and main computer programs and prepares specifications that indicate process-outline of the overall batch job.

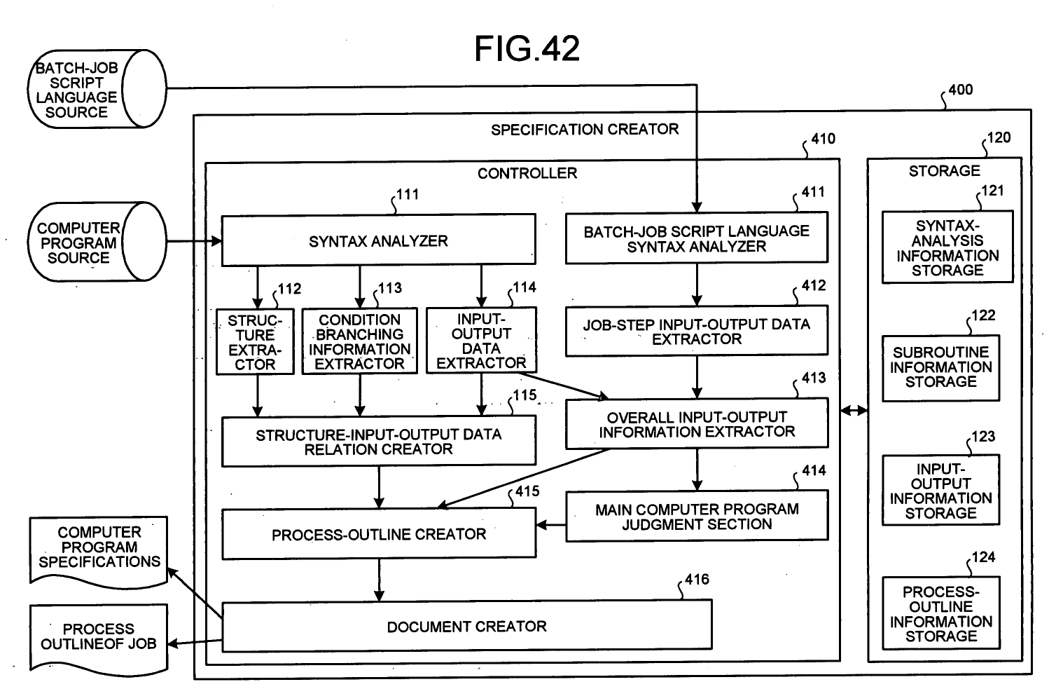

To start with, a composition of the specification creator according to the fourth embodiment is described. FIG. 42 is a functional block diagram of the specification creator according to the fourth embodiment. For the sake of convenience, same reference numerals are used for components that perform the same function as the components in FIG. 1 and detailed description of these components is omitted.

As shown in FIG. 42, a specification creator 400 includes a controller 410. The controller 410, in addition to a functional components included in the controller 110 in FIG. 1, includes a batch-job script language syntax analyzer 411, a job-step input-output data extractor 412, an overall input-output information extractor 413, a main computer program judging section 414. The controller 410 further includes a process-outline creator 415 instead of the process-outline creator 116 and a document creator 416 instead of the document creator 117.

The batch-job script language syntax analyzer 411 reads a batch-job script language source and generates batch-job analysis information that includes information extracted of call computer program or name of file used in each job step.

The job-step input-output data extractor 412, makes a judgment of whether a file is used for input, or is used for output, or is deleted for each job step from the batch-job analysis information generated by the batch-job script language syntax-analyzer 411. The job-step input-output data extractor 412 generates result of the judgment as job-step input-output information.

The overall input-output information extractor 413 determines files used for input and files used for output as a whole job by using the job-step input output information generated by the job-step input-output data extractor 412 and the input-output information list generated by the input-output data extractor 114.

The main computer program judging section 414 extracts a job step that uses input-output files of the overall job determined by the overall input-output information extractor 413 and generates a list of computer programs that is called at the job-step extracted.

When the main computer program judging section 414 generates the list of computer programs called at the job step extracted, if the computer program that is called is a utility program, the computer program is excluded from the list of computer programs.

The process-outline creator 415 generates process-outline information of each computer program that is included in the batch job. The process-outline creator 415 also generates batch-job process-outline by combining the input-output files determined by the overall input-output information extractor 413 and the list of computer programs generated by the main computer program judging section 414.

Thus, the process-outline creator 415 generates the batch-job process-outline by using the input-output files determined by the overall input-output information extractor and the list of computer programs generated by the main computer program judging section 414 in addition to the process-outline information of each process computer program. Therefore, the specification creator 400 can prepare a process-outline of overall job process in addition to specifications of the computer program.

The document creator 416 generates computer program specifications by using the process-outline information generated by the process-outline creator 415. The document creator 416 also forms the batch-job process-outline in a predetermined format and generates process-outline of the overall job.

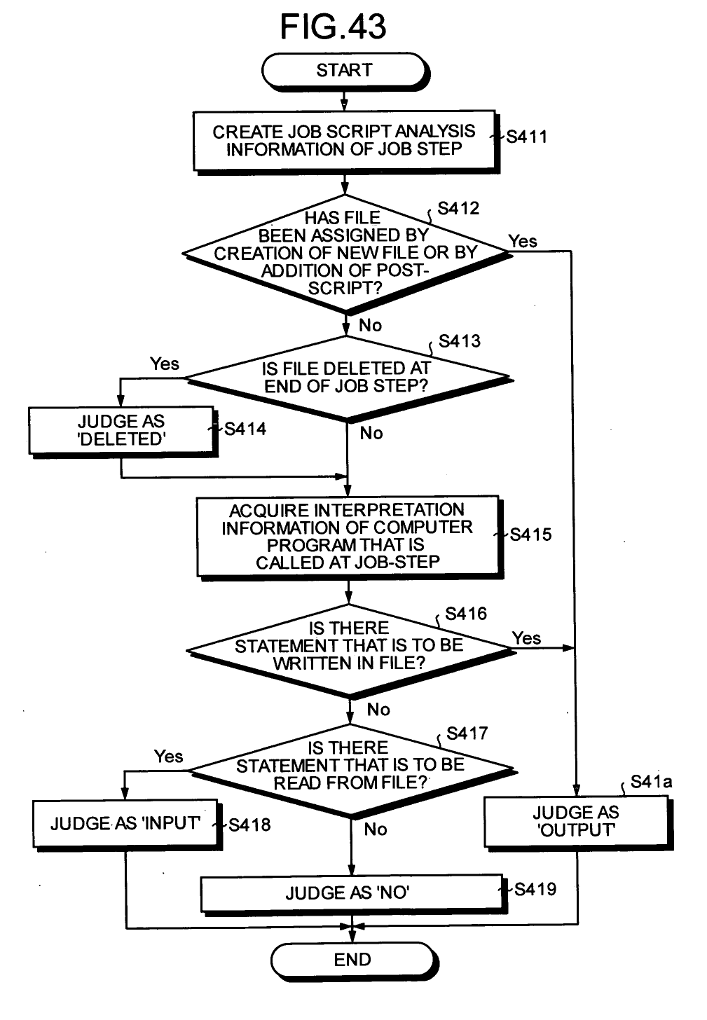

A processing procedure of input-output judging process by the job-step input-output data extractor 4.12 is described below. FIG. 43 is a flow chart of the processing procedure of the input-output judging process by the job-step input-output data extractor 412.

As shown in FIG. 43, the job-step input-output data extractor 412 creates job script analysis information of the job step from the batch-job analysis information generated by the batch-job script language syntax-analyzer 411 (step S411).

The job-step input-output data extractor 412 examines if the file is assigned either by creation of a new file or by addition of a post script by analyzing the job script analysis information of the job step (step S412). If the file is assigned either by creation of a new file or by addition of a post script, the file is judged to be an output file (step S41a).

Whereas, if the file is not assigned by any of creation of anew file or by addition of a post script, the job-step input-output data extractor 412 examines if at the end of the job step the file is deleted (step S413). If the file is deleted, the job-step input-output data extractor 412 judges the file as a file to be deleted (step S414).

Further the job-step input-output data extractor 412 acquires syntax-analysis information of the computer, program that is called at the job step (step S415) and examines if there is a statement to be written in the file (step S416). If there is a statement to be written, the job-step input-output data extractor 412 judges the file as an output file (step S41a).

Whereas, if there is not statement to be written in the file, the job-step input-output data extractor 412 examines if there is a statement to be read from the file (step S417). If there is a statement to be read, the job-step input-output data extractor 412 judges the file to be an input file (step S418). If there is no statement to be read, the job-step input-output data extractor 412 judges the file to be neither an input nor an output file (step S419).

Thus, the job-step input-output data extractor 412 makes a judgment of whether the file is used for input or for output by using the computer program syntax-analysis information and the job script analysis information, thereby enabling generation of job-step input-output information at each job step.

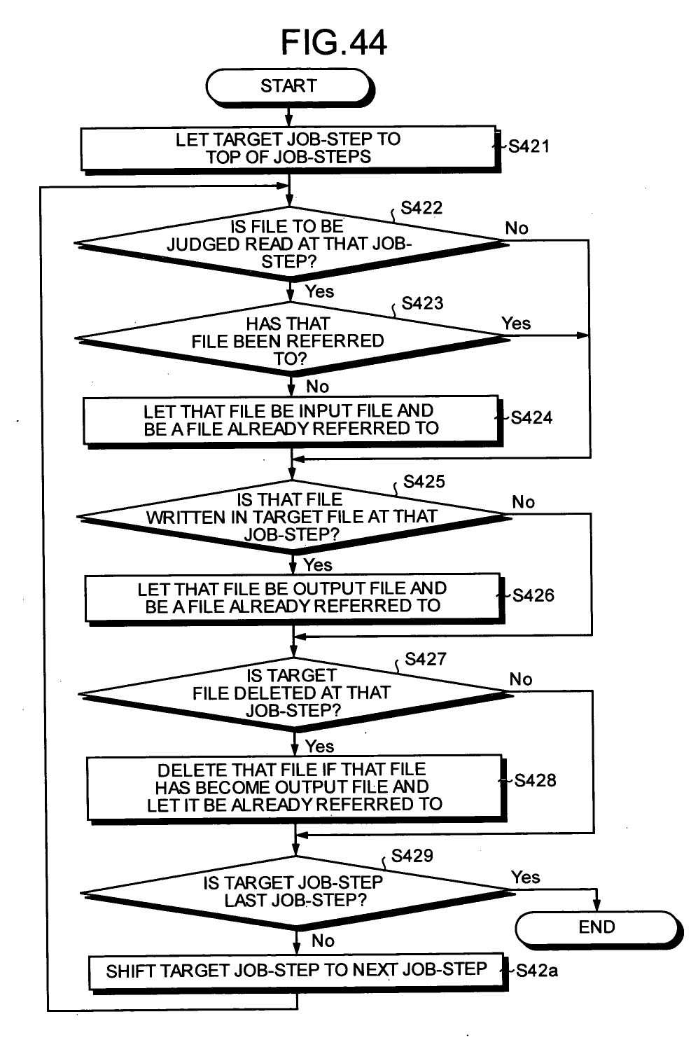

A processing procedure of a file input-output judging process as an overall job by the overall input-output information extractor 413 is described below. FIG. 44 is a flow chart of the processing procedure of the file input-output judging process as the overall job by the overall input-output information extractor.

As shown in FIG. 44, the overall input-output information extractor 413 lets a target job step to be a job step at the top (step S421) and examines if the file to be judged is read at that job step (step S422).

If the file to be judged is read at that job step, the overall input-output information extractor 413 examines if that file is already referred to (step S423). If the file is not referred to, that file is let to be an input file and be a file that is already referred to (step S424).

The overall input-output information extractor 413 examines if the file to be judged is written at that job step (step S425). If the file is written at that job step, that file is let to be an output file and be a file that is already referred to (step S426).

Further, the overall input-output information extractor 413 examines if the file to be judged is deleted at that job step (step S427). In a case where the file is deleted at that job step, if the file is an output file the file is deleted and is let to be a file already referred to (step S428).

The overall input-output information extractor 413 then examines if the job step is the last job step (step S429). If the job step is the last job step, the overall input-output information extractor 413 lets the job step to be judged to be the next job step (step S42a) and the process returns to step S422. If the job step is the last job step, the overall input-output information extractor 413 ends the process.

Thus, the overall input-output information extractor 413 makes a judgment of input and output of the file as a whole batch job. As a result, the specification creator 400 can prepare specifications in which the input files and the output files of the overall batch job are mentioned.

A processing procedure of a utility exclusion process by the main computer program judging section 414 is described below. In the utility exclusion process, while extracting the main computer program, a computer program is extracted by excluding a normal computer program called utility.

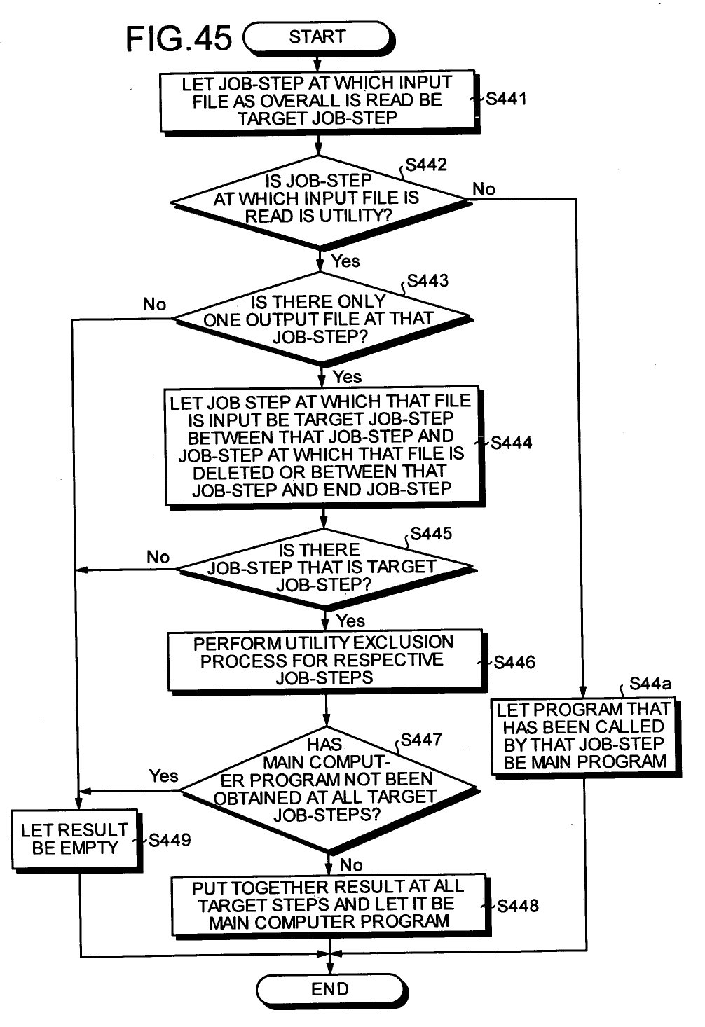

FIG. 45 is a flow chart of the processing procedure of the utility exclusion process. As shown in FIG. 45, in the utility exclusion process, to start with, a job step at which the overall input files are read is let to be a target job step (step S441).

The main computer program judging section 414 examines if the job step at which the input file is read is a utility (step S442). If the job step at which the input file is read is not a utility, the main computer program judging section 414 lets a computer program that is called by the job step to be the main computer program (step S44a).

If the job step at which the input file is read is a utility, the main computer program judging section 414 examines if there is only one output file of that job step (step S443). If there are more than one files, the main computer program judging section 414 lets the result of the utility exclusion process to be empty (null) (step S449).

Whereas, if there is only one output file of that job step, the main computer program judging section 414 lets a job step that inputs that file between that job step file and the job step at which that file is deleted or an end job step be a target job step (step S444). The main computer program judging section 414 examines if there is a target job step (step S445). If there is no target job step, the main computer program judging section 414 lets the result of the utility exclusion process to be empty (step S449). If there is a job step for which the main computer program is obtained, the main computer program judging section 414 collects results of processes at all target job steps and lets it to be the main computer program (step S448).

Thus, the main computer program judging section 414 excludes the utility by performing the utility exclusion process. As a result, the specification creator 400 can exclude the utility computer program from the main program of the batch job.

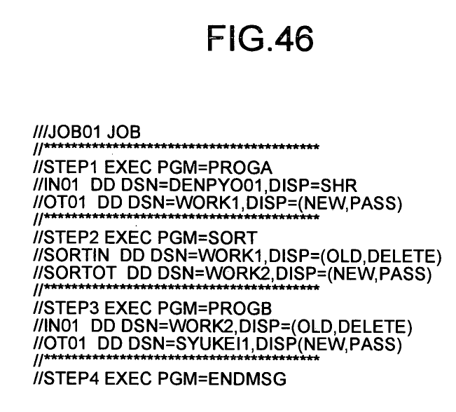

An example of process-outline of the overall batch job that is generated by the specification creator 400 is described below. FIG. 46 is an example of a batch-job script. A batch job that includes job steps STEP 1 to STEP 4 is shown in FIG. 46.

In this example, to start with, a computer program PROG A is called in a first job step STEP 1. In this case, a file DENPYO 1 and a file WORK 1 are assigned to external names IN 01 and OT 01 respectively as files to be used by the computer program PROG A.

In other words, DENPYO 1 and WORK 1 are assigned respectively to input-output targets that are referred as names IN 01 and OT 01 in the computer program PROG A. An access method of files is described by a parameter called DISP. SHR signifies reading and writing of an existing file and (NEW, PASS) signifies creating of a new file.

Files are assigned similarly in STEP 2 to STEP 4. A display parameter (OLD, DELETE) in STEP 2 and STEP 3 signifies reading of existing files and deletion at the end.

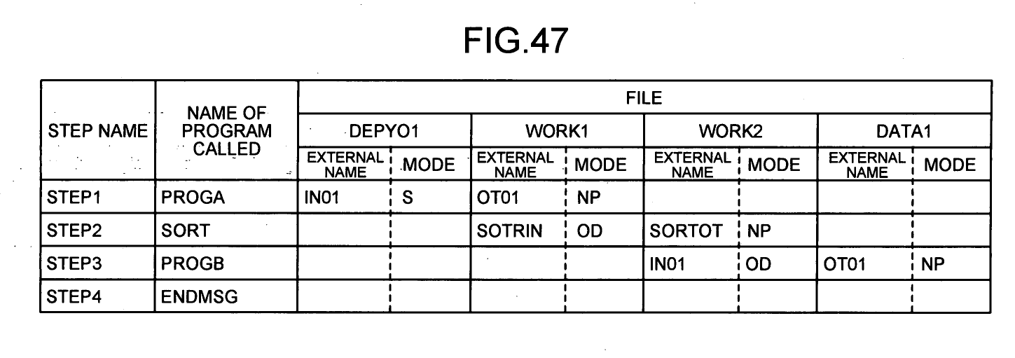

FIG. 47 is a tabular representation of batch-job information that is generated by the batch-job script language syntax analyzer 411 from the batch-job script shown in FIG. 46. The job-step input-output data extractor 412 by using the batch-job analysis information makes a judgment of input-output files that are used at each step.

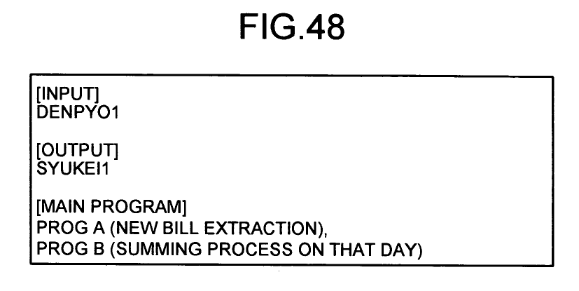

FIG. 48 represents a process-outline of an overall batch job that is generated from the batch-job script shown in FIG. 46. As shown in FIG. 48, the specification creator 400 extracts DENPYO 1 as an input file of the overall batch process and extracts SYUKEI 1 as an output file of the overall batch job.

The specification creator 400 extracts the computer programs PROG A and PROG B as main computer programs that execute the processing of these files. Outputting this information enables to understand which data is handled by the overall batch process and which process is performed. Regarding the main computer program, the process-outline can be added by using the process-outline information stored in the process-outline information storage 122.

Thus, according to the fourth embodiment, the batch-job script language syntax analyzer 411 generates the batch-job analysis information from the batch-job script language source. The job-step input-output data extractor 412 generates the job-step input-output information from the batch-job analysis information. The overall input-output information extractor 413 determines the input-output files as the overall job by using the job-step input-output information and the list of input-output information generated by the input-output data extractor 114. The main computer program judging section 414 generates the list of computer programs that are called at the job step that uses input-output files as the overall job determined by the overall input-output information extractor 413. This enables to facilitate the understanding of the outline of the overall batch-job process.

A screen transition diagram is useful (effective) as a document to understand an outline of an online system. A specification creator that generates automatically the screen transition diagram of the online system is described in a fifth embodiment.

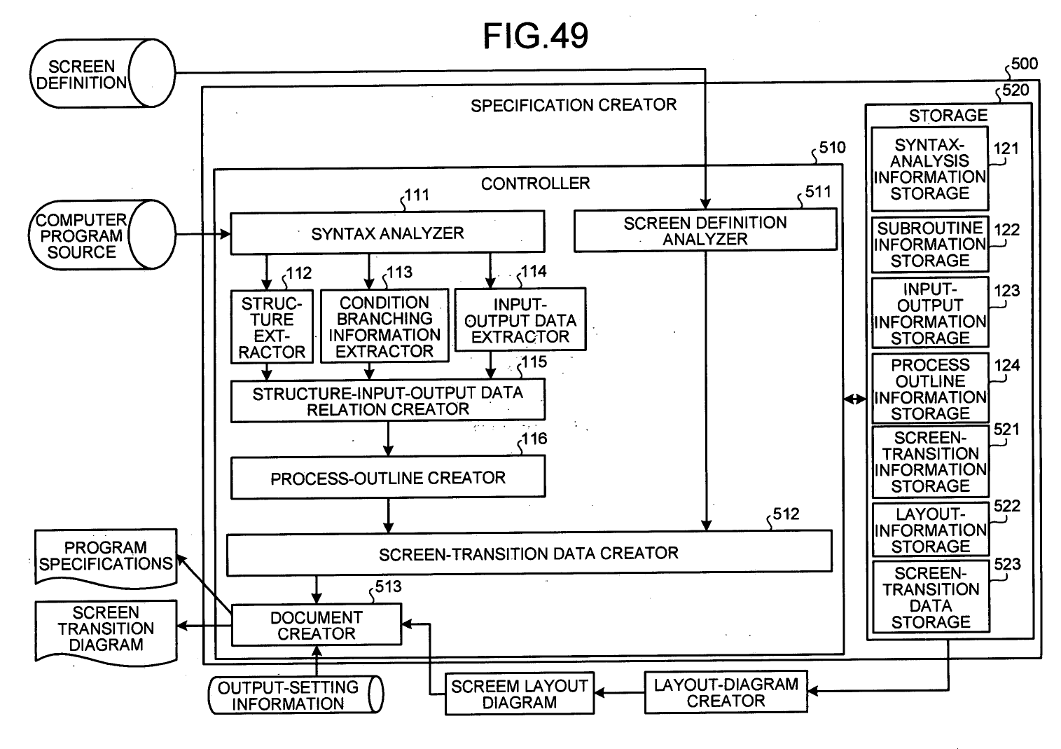

To start with, a composition of the specification creator according the fifth embodiment is described. FIG. 49 is a functional block diagram of a specification creator 500 according to the fifth embodiment. For the sake of convenience, same reference numerals are used for components that perform the same function as the components in FIG. 1 and detailed description of these components is omitted.

As shown in FIG. 49, a specification creator 500 includes a controller 510 and a storage 520. The storage 520 stores information like information used by the controller 510 and interim results of processes performed by the controller 510. The controller 510, in addition to functional components included in the controller 110 in FIG. 1, includes screen definitions analyzer 511, and a screen transition data creator 512. The controller 510 further includes a document creator 513 instead of the document creator 117.

The storage 520, in addition to storages included in the storage 120 in FIG. 1 includes a screen-transition information storage 521, a layout information storage 522, and a screen-transition data storage 523.

The screen definition analyzer 511 reads an screen definition and generates layout information of each screen and distribution definition information extracted from transition conditions between screens. The screen definition analyzer 511 also generates from the distribution definition information, screen transition information which is what the next screen of a screen is or what computer program calls from a screen, what is a transition condition in that case etc.

The screen-transition information storage 521 stores the screen transition information generated by the screen definitions analyzer 511. The layout information storage 522 stores the layout information generated by the screen definitions analyzer 511.

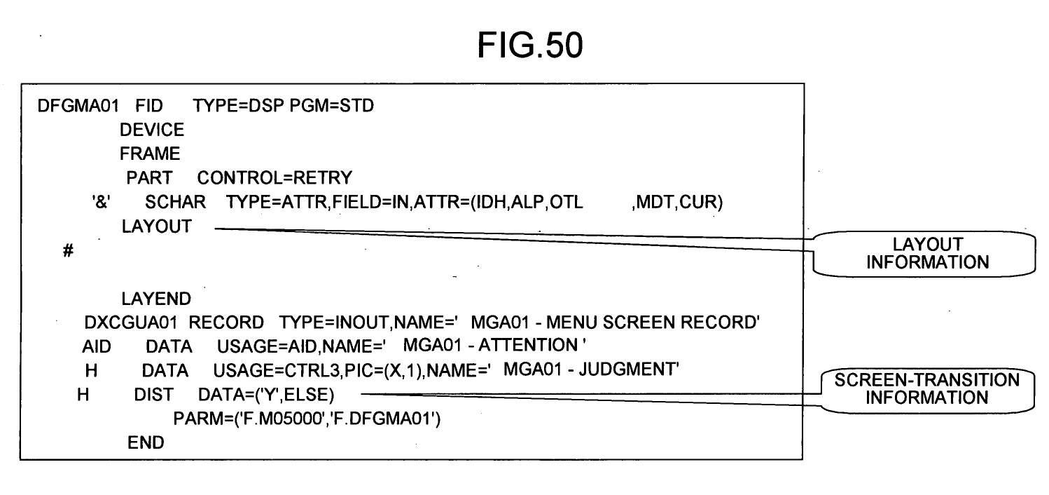

FIG. 50 is an example of screen definitions. As shown in FIG. 50, the layout information is generated from information defined between LAYOUT and LAYEND. The screen transition information is generated from information that is defined by a statement DIST.

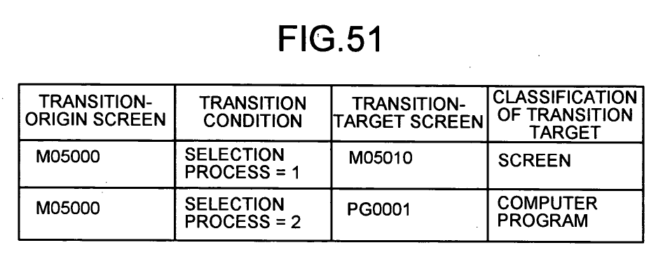

FIG. 51 is an example of screen transition information. As shown in FIG. 51, the screen transition information associates source, transition condition, destination, and kinds of destination. In this example, a source screen M05000 undergoes transition to a screen M05001 under a transition condition SELECTION PROCESS=1 and undergoes transition to a computer program PG0001 under a transition condition SELECTION PROCESS=2.

The screen-transition data creator 512 generates screen transition data in which the overall screen transition diagram is structured with a specific screen as a starting point. The screen-transition data creator 512 generates the screen transition data by using the screen transition information generated by the screen definitions analyzer 511 and the process-outline information generated by the process-outline creator 116.

In other words, the screen-transition data creator 512 creates screen-transition data that expresses the overall transition information in the form of a nesting structure. The screen-transition data creator 512 creates the screen-transition data based on the screen transition information connecting from the source to the destination with a specific screen as a starting point.

For example, if there is transition information FROM A SCREEN A TO A SCREEN B and transition information FROM THE SCREEN B TO A COMPUTER PROGRAM C, the screen B being common, a link flow viz. SCREEN A→SCREEN B→COMPUTER PROGRAM C is possible. Huge screen-transition data can be generated by performing the same process for the entire screen-transition information.

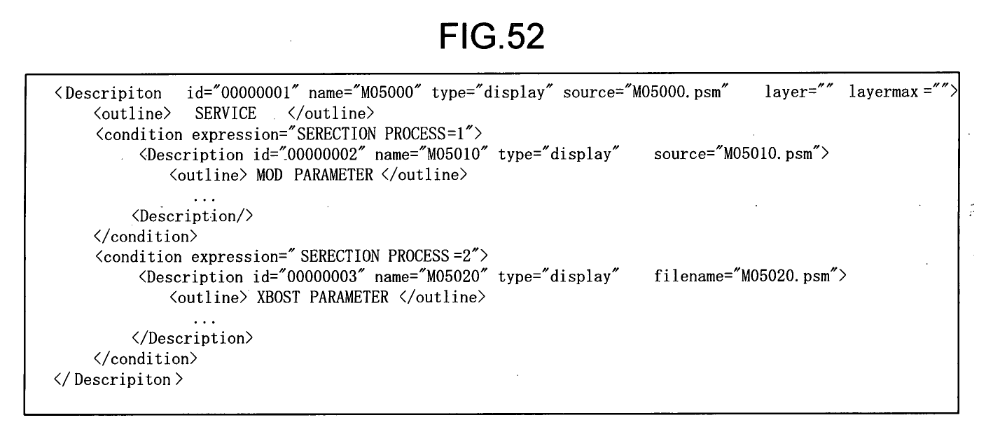

The screen-transition data creator 512 creates separate computer program-outline statement from the process-outline information generated from the computer program and data that is extracted from input-output files data from each file. The screen-transition data creator 512 generates screen transition data shown in FIG. 52 by merging the data created with the screen transition data. For example, if there is writing from the computer program C to a file X, it results in a flow SCREEN A→SCREEN B→COMPUTER PROGRAM C→FILE X with the screen transition data.

The screen-transition data storage 523 stores the screen transition data generated by the screen-transition data creator 512.

The document creator 513 generates computer program specifications from the process-outline information as well as converts the screen transition diagram data to a predetermined format as screen transition diagram and generates screen transition diagram.

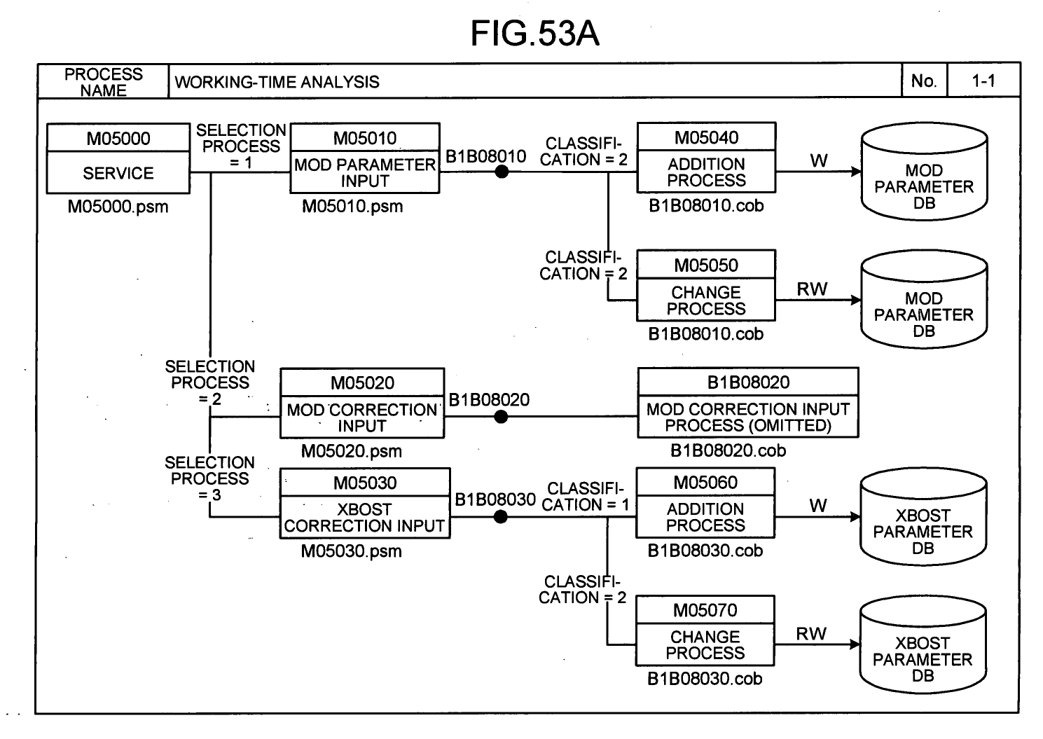

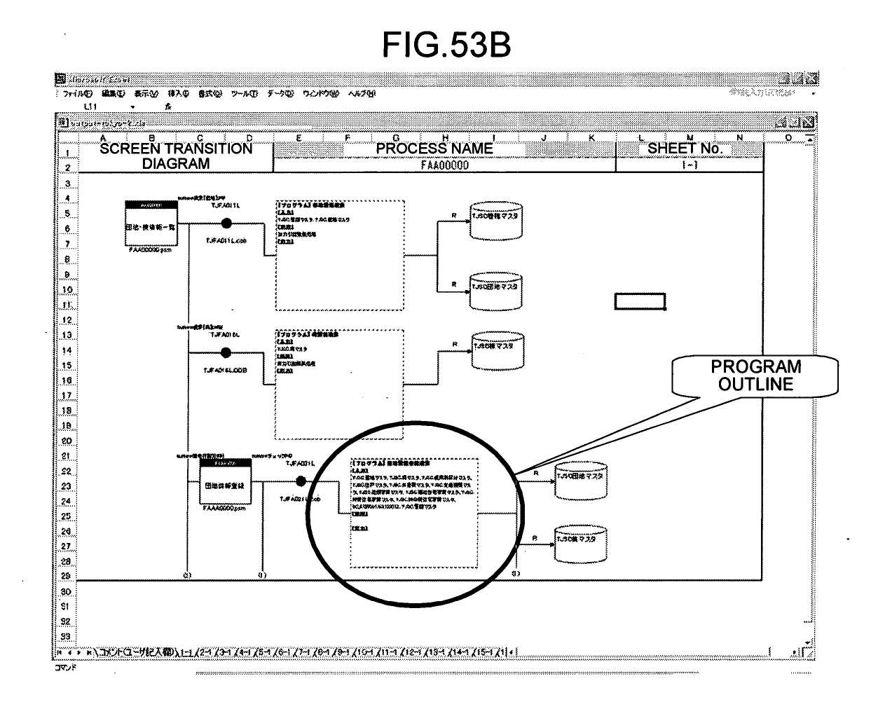

FIG. 53A is an example of a screen transition diagram. In FIG. 53A, a flow SCREEN M05000→SCREEN M05010→COMPUTER PROGRAM M05040→MOD PARAMETER DB is shown. FIG. 53B is another example of a screen transition diagram. In this example, a computer program-outline is inserted in the screen transition diagram.

The document creator 513 performs page control by using information like specified number of screens or pages as output setting information. In a case where the destinations that cannot be accommodated in one page, to know the destinations at a glance, location information of on which page and where the destination is, is entered at an end of the transition diagram. Or, without performing the page control and without specifying the number of screen that can be accommodated in one page, a big screen-transition diagram can be generated.

When the screen-transition diagram is generated, an overall flow and details of each screen can be associated by linking from each screen of the screen-transition drawing to a screen layout diagram that is generated apart.

The document creator 513 can also output a screen layout diagram that is created from the layout information generated by the screen definitions analyzer 511.

Thus, according to the fifth embodiment, the screen definitions analyzer generates the screen-transition information from the screen definitions. The screen-transition data creator 512 generates screen transition data in which the overall screen transition diagram is structured with a specific screen as a starting point. The screen-transition data creator 512 generates the screen transition data by using the screen transition information generated by the screen definitions analyzer 511 and the process-outline information generated by the process-outline creator 116. The document creator 513 converts the screen transition diagram data generated by the screen-transition data creator 512 to a predetermined format and generates the screen transition diagram. This facilitates the understanding of the process-outline of the online system.

The computer program specifications generated by the specification creator 100 that is described in the first embodiment is effective for understanding of the process-outline of a computer program. In many cases, after understanding the process-outline of a computer program, it is necessary to understand details of the process structure of the computer program. A specification creator that generates details of the relationship between the call structure of the computer program and the input-output information as a process structure diagram is described in a sixth embodiment.

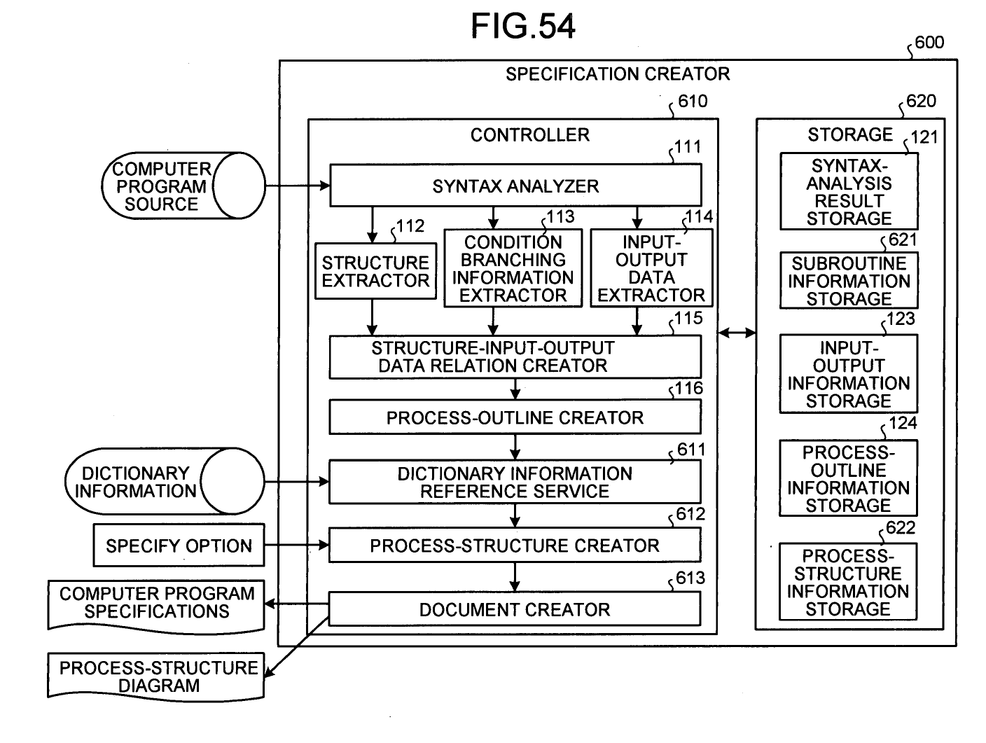

To start with, a composition of the specification creator according the sixth embodiment is described. FIG. 54 is a block diagram that defines the function of the specification creator according to the sixth embodiment. For convenience, same reference numbers are used for the components that perform the same functions as the components in FIG. 1 and detailed description of these components is omitted.

As shown in FIG. 54, a specification creator 600 consists of the controller 610 and the storage 620. The storage 620 stores temporary information of the processes performed by the controller 610. The controller 610 consists of function components defined in the controller 110 in FIG. 1, the dictionary information reference service 611, a process-structure creator 612, and a document creator 613 instead of the document creator 117.

The storage 620 consists of storages defined in the storage 120 in FIG. 1, process-structure information storage 622, and subroutine information storage 621 instead of the subroutine information storage 122.

The dictionary-information reference service 611, generates subroutine information that includes information of names of computer program and names of variable etc, by referring the dictionary information. The dictionary-information reference service 611 stores the subroutine information in the subroutine information storage 621. In other words, the subroutine information storage 621 stores the information defined in the dictionary in addition to the information stored in the subroutine information storage 122.

The process-structure creator 612 converts the subroutine information stored in the subroutine information storage 621 into a tabular form and stores it in the process-structure information storage 622. The process-structure creator 612 can add optional information that the user can select to the subroutine information in a tabular form stored in the process-structure information storage 622.

The option includes addition of information like the condition of subroutine calls, call arguments or parameters which programs use when called, jump target, classification of statement to the process-structure diagram.

The document creator 613 generates both the computer program specifications from the process-outline information and the process-structure diagram from the subroutine information in a tabular form stored in the process-structure information storage 622.

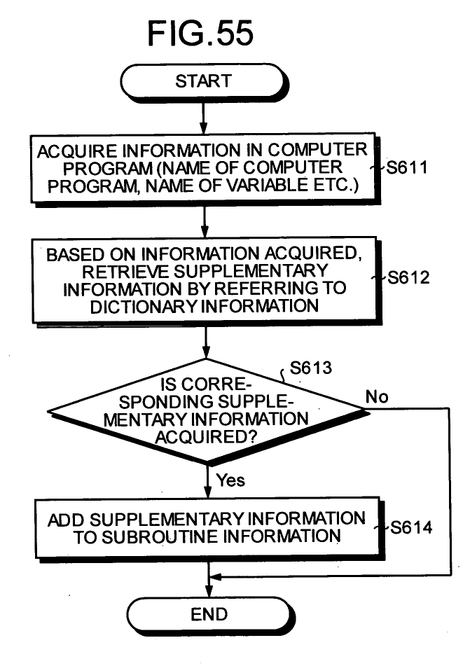

A processing procedure of the dictionary information reference service is described below. FIG. 55 defines the flow chart of the process of consulting the dictionary information. As shown in FIG. 55, the dictionary information reference service 611 acquires the name of a computer program, the name of variable, the subroutine name etc. from the computer program (step S611) and refer to the dictionary information by using the information acquired (step S612).

The reference service 611 makes a judgment of whether the supplementary information is acquired (step S613). If the supplementary information is acquired, the dictionary information reference service 611 adds the information to the subroutine information storage 621. If the supplementary information is not acquired, the dictionary information reference service 611 ends the process as it is (step S614).

Thus, the dictionary reference service 611 refers to the dictionary information and adds the information acquired by the dictionary information to the subroutine information in the subroutine information storage 621. As a result, the information in the dictionary can be added to the process structure diagram.

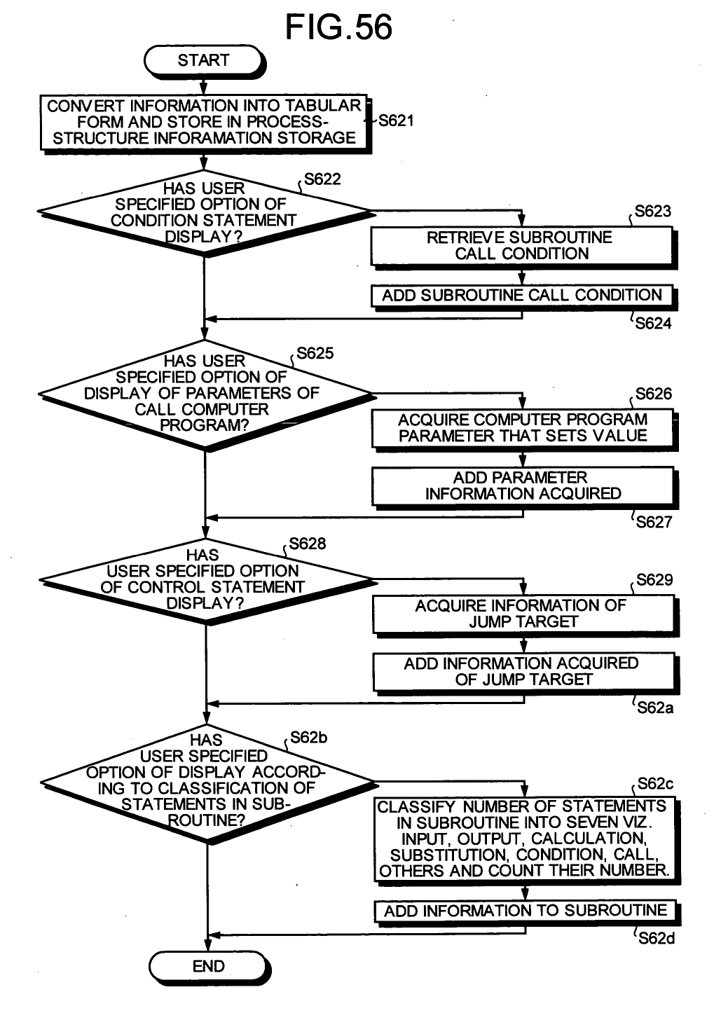

A processing procedure of the process structure creator 612 is described below. FIG. 56 is a flow chart of the processing procedure of the process structure creator 612. As shown in FIG. 56, the process structure creator 612 converts the subroutine information stored in the subroutine information storage 621 into tabular form and stored in the process structure information storage 622 (step S621).

The process structure creator 612 reads the option assignment and examines if the user has specified an option of a condition statement display (step S622). If the user has selected the option to show the condition statement, the process structure creator 612 retrieves a subroutine call condition (step S623) and adds the subroutine call condition to the subroutine information in the process structure information storage (step S624).

The process structure creator 612 then examines if the user has specified an option to show the arguments of the call computer program (step S625). If the user has specified the option of parameter information display, the process structure creator 612 acquires a computer program arguments and parameters, which values are set before the program call (step S626), and adds the parameter information to the process structure information storage 622 (step S624).

The process structure creator 612 examines if the user has specified an option of control statement display of the call computer program (step S628). If the user has specified the option of control statement display, the process structure creator 612 acquires information of jump target of a jump statement and adds the information of jump target to the subroutine information in the process structure information storage 622 (step S62a).

Further, the process structure creator 612 examines if the user has specified an option of display according to classification of statements in the subroutine (step S62b). If the user has specified the option to display the classification of statements in the subroutine, the process structure creator 612 classifies the statements in the subroutine into seven classes viz. INPUT, OUTPUT, CALCULATION, SUBSTITUTION, CONDITION, CALL, OTHERS and counts the number in each categories (step S62c). The process structure creator 612 then adds the number of statements according to classification to the subroutine information in the process structure information storage 622 (step S62d).

Thus, the process structure creator 612 converts the subroutine information stored in the subroutine information storage 621 into a tabular form and adds option information based on the option specified to the subroutine information converted. As a result, the process structure creator 612 generates the process structure diagram with the option information.

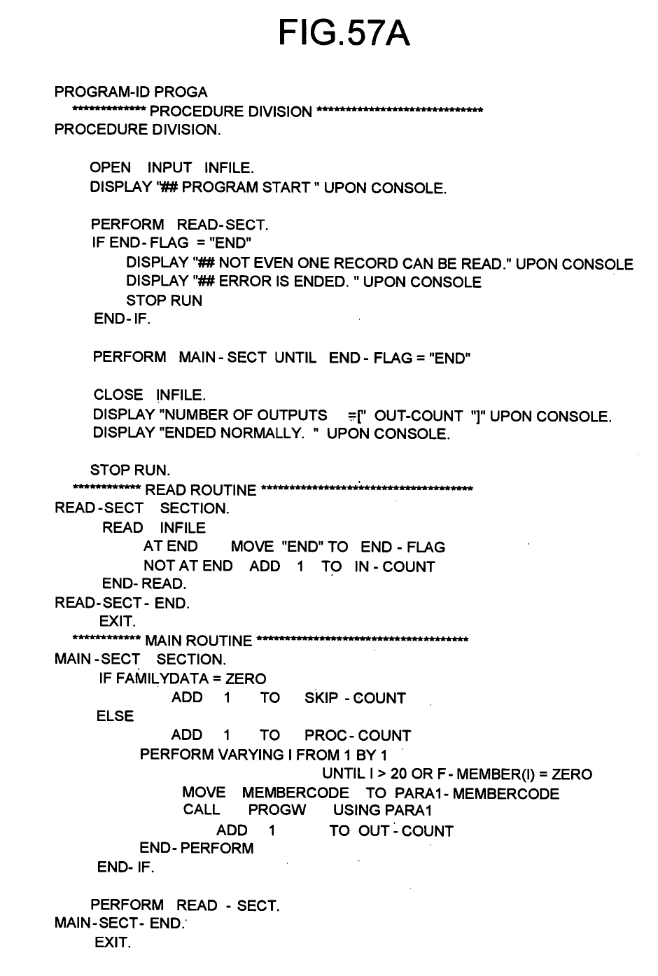

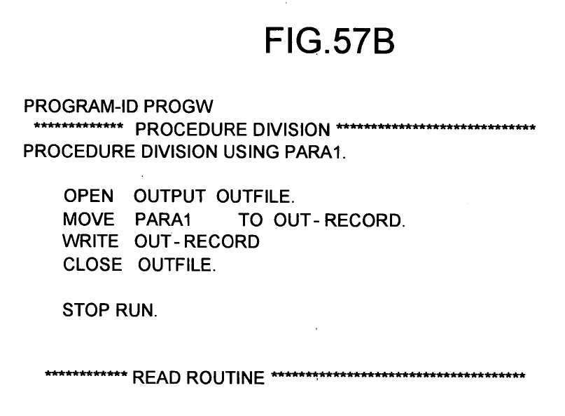

The process structure diagram generated by the specification creator 600 according to the sixth embodiment is described below. FIGS. 57A and 57B represent a target computer program that generates the process structural diagram. FIG. 57A represents a computer program at a call origin and FIG. 57B represents a computer program at a call target.

As shown in FIG. 57A, the computer program at the call origin is named as PROG A (PROGRAM-ID PROG A) and includes two sections viz. READ-SECT and MAIN-SECT. The MAIN-SECT calls a computer program PROG W. FIG. 57B represents the computer program PROG W.

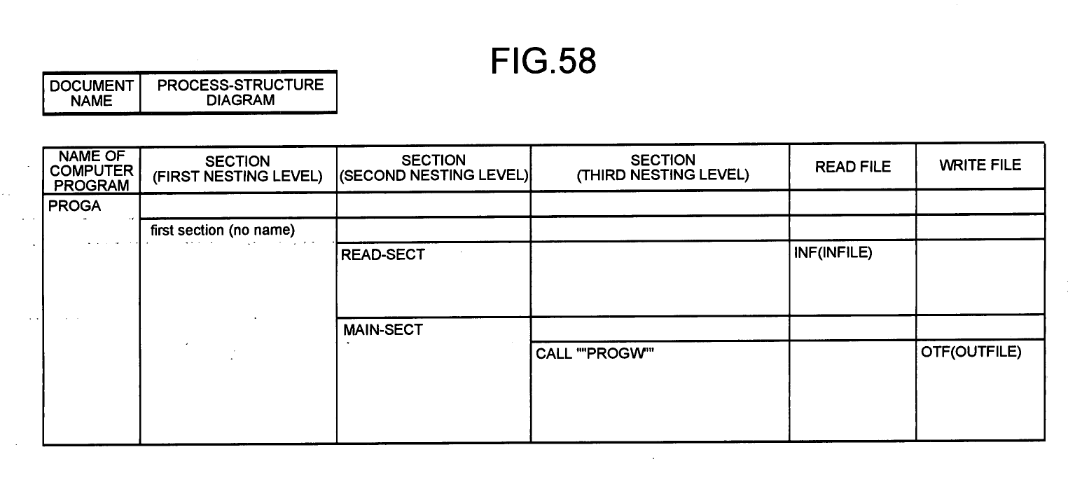

FIG. 58 is an example of the process structural diagram that is generated from computer programs shown in FIGS. 57A and 57B. In FIG. 58, a column of SECTION (FIRST NESTING LEVEL) to SECTION (THIRD NESTING LEVEL) indicate a call structure of the computer program and a column of read file and write file indicate input-output files corresponding to the call structure.

Concretely, the process structure diagram depicts that PROG A has READ-SECT and MAIN-SECT as the second nesting level section and the READ-SECT uses a file INFILE as an input file. The process structure diagram further depicts that the MAIN-SECT calls PROG W by a CALL statement and an OUTFILE is used as an output file in the computer program.

Thus, according to the sixth embodiment, the dictionary information reference service 611 retrieves the information from the dictionary information and adds the information to the subroutine information. The process structure creator 612 converts the subroutine information into a tabular form and adds to the subroutine information the information specified by the option. The document creator 613 generates the process structure with the dictionary information and the option information from the subroutine information in tabular form. As a result, the understanding of the detailed relationship between the call structure of the computer program and the input-output information is facilitated.

In other words, since the input-output information that includes all subroutines at the call target is shown in a tabular form, it is easy to understand the input-output information to which a certain subroutine may make an access including a lower rank subroutine.

The specification creator that generates the process structure diagram, which facilitates the understanding of the computer program process structure, is described in the sixth embodiment. This diagram is effective in understanding the specification of the static structure of the computer program, however, to capture the actual behavior of a computer program, static process structure information of the computer program is not sufficient. In such case, execution log information that is obtained by executing the computer program is effective in understanding the actual behavior of the computer program. A specification creator that adds the execution log information to the process structure diagram of the computer program is described in a seventh embodiment.

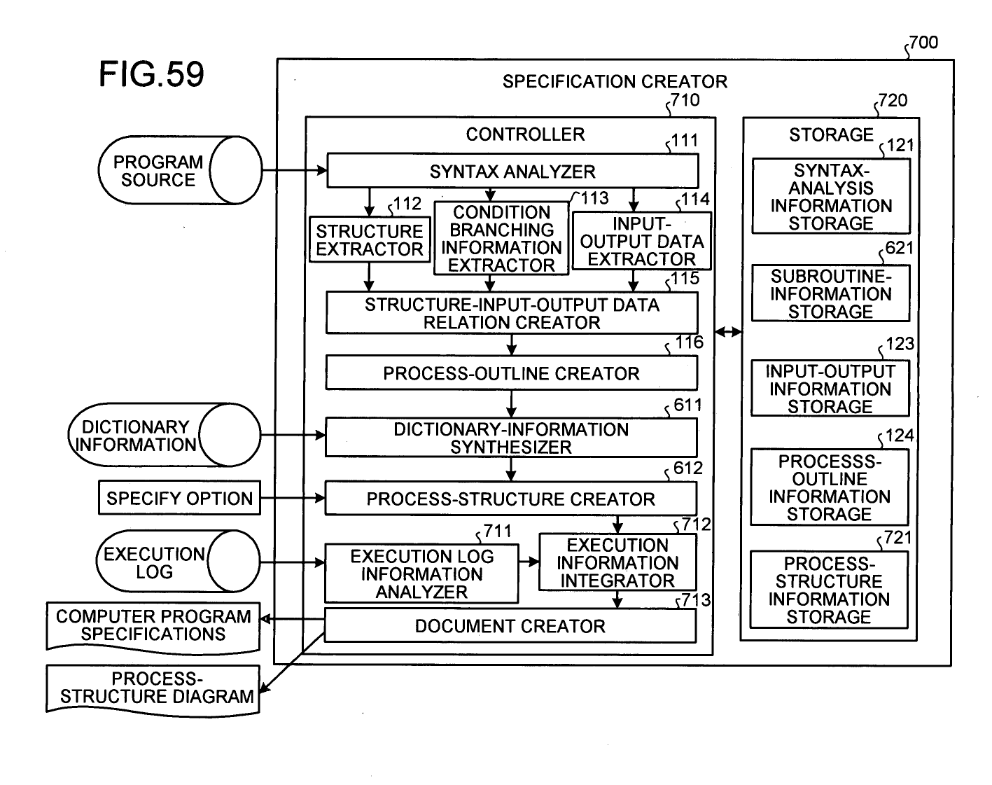

To start with, a composition of the specification creator according to the seventh embodiment is described. FIG. 59 is a block diagram that defines the function of the specification creator according to the seventh embodiment. For convenience, same reference numbers are used for the components that perform the same functions as the components in FIG. 54 and detailed description of these components is omitted.

As shown in FIG. 59, a specification creator 700 consists of a controller 710 and storage 720. The controller 710 consists of function components defined in the controller 610 in FIG. 54, an execution log information analyzer 711, an execution information integrator 712, and a document creator 713 instead of the document creator 613. The storage 720 consists of process-structure information storage 721 instead of the process-structure information storage 622 in the storage 620 in FIG. 54.

The execution log information analyzer 711 extracts execution times information for each subroutine from the execution log that is obtained by execution of a computer program. The execution log information analyzer 711 passes the execution times information to the execution information integrator 712.

The execution information integrator 712 performs color classification of a field corresponding to each subroutine of the process structure diagram based on the number of times of execution for each subroutine received from the execution log information analyzer 711. The execution information integrator 712 stores the information classified in the process-structure information storage 721. In other words, the process-structure information storage 721 stores execution information of each subroutine in addition to the information stored in the process-structure information storage 622.

The document creator 713 generates both computer program specifications from the process-outline information and a process structure diagram that is colored based on the subroutine information of the execution information stored in the process-structure information storage 721.

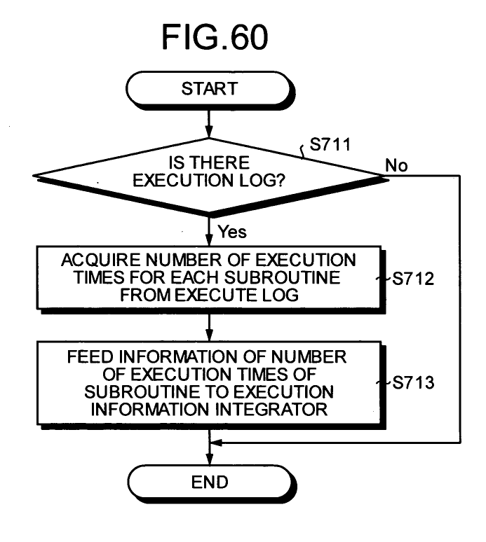

A processing procedure of the execution log analyzer 711 is described below. FIG. 60 is a flow chart of the processing procedure of the execution log information analyzer 711. As shown in FIG. 60, the execution log information analyzer 711 makes a judgment of whether there is an execution log (step S711).

If there is an execution log, the execution log information analyzer 711 acquires the number of execution times for each subroutine from the execution log (step S712) and passes the number of execution times with the subroutine name to the execution information integrator 712 (step S713). Whereas, if there is no execution log, the execution log information analyzer 711 ends the process as it is.

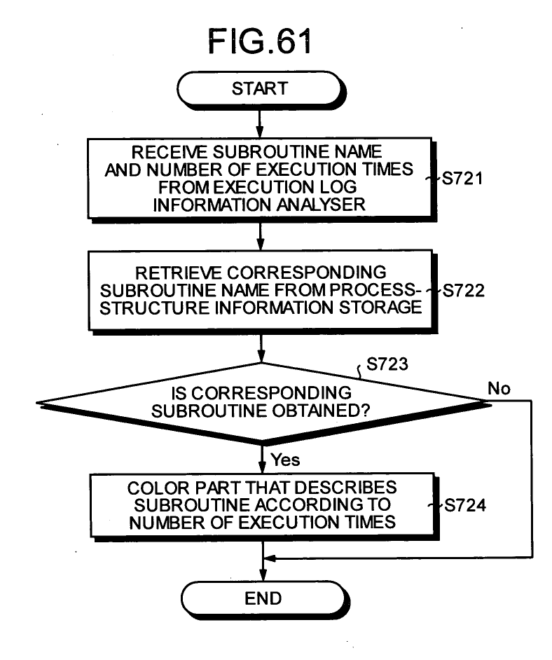

A processing procedure of the execution information integrator 712 is described below. FIG. 61 is a flow chart of the processing procedure of the execution information integrator 712. As shown in FIG. 61, the execution information integrator 712 receives the subroutine name and the numbers of execution times from the execution log information analyzer 711 (step S721). The integrator 712 retrieves the process-structure information storage 721 by using the subroutine name received (step S722).

The execution information integrator 712 examines if the subroutine could be retrieved from the process-structure information storage 721 (step S723). If the subroutine could be retrieved, the execution information integrator 712 adds to the process-structure information storage 721 information of execution information in the process structure diagram of the subroutine according to the number of execution times (step S724). Whereas, if the subroutine could not be retrieved, the execution information integrator 712 ends the process as it is.

Thus, the execution log information analyzer 711 extracts the number of execution times of the subroutine by analyzing the execution log. The execution information integrator 712 adds the information and colors the field of the subroutine in the process-structure diagram based on the number of execution times of the subroutine. As a result, the process structure diagram that is colored based on the execution information can be generated.

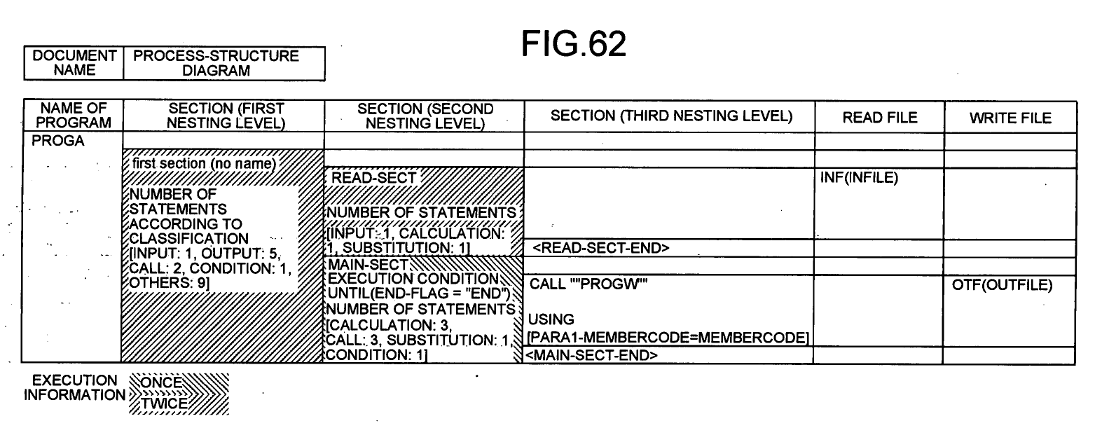

The process-structure diagram generated by the specification creator 700 according to the seventh embodiment is described below. FIG. 62 is an example of a process structural diagram that is generated from the computer programs shown in FIGS. 57A and 57B.

As shown in the FIG. 62, in the process structure diagram, fields corresponding to READ-SECT and MAIN-SECT are netted in different directions according to the number of execution times. In reality, different colors are assigned instead of netting to these fields.

The process structure diagram also shows the case where an option is specified by the user that adds information like subroutine call condition, parameter, jump target, statement classification etc. to the process structure diagram includes. For example, number of statements according to classification like INPUT: 1, CALCUATION: 1, SUBSTITUTION: 1 are output to READ-SECT.

Thus, according to the seventh embodiment, the execution log information analyzer 711 analyzes the execution log and extracts the number of execution times for each subroutine. The execution information integrator 712 adds the execution information to the process-structure information storage 721, which is colored on the diagram based on the number of execution times for each subroutine that is extracted by the execution log information analyzer 711. The document creator 713 generates the process structure diagram and shows the information of the subroutine information by using colors in the diagram, which is added by the execution information integrator 712. As a result, the caption of the actual behavior of the program can be facilitated.

In the computer program specifications that are generated by the specification creators according to the first to the seventh embodiment, by providing a hyper link to data or objects in the specifications, cross referring between the specifications, or referring to other documents can be made possible.

For example, in a case of the screen transition diagram, if a computer program name in the diagram is clicked, a jump to the computer program-outline can be made possible. If a screen graphic item is clicked, a jump to screen layout that is generated by other tool can be made possible.

The specification creators are described in the first to the seventh embodiments. By realizing the configurations of the specification creators by software, specification generating computer program that have similar functions can be obtained. A computer system that executes the specification generating computer program is described below.

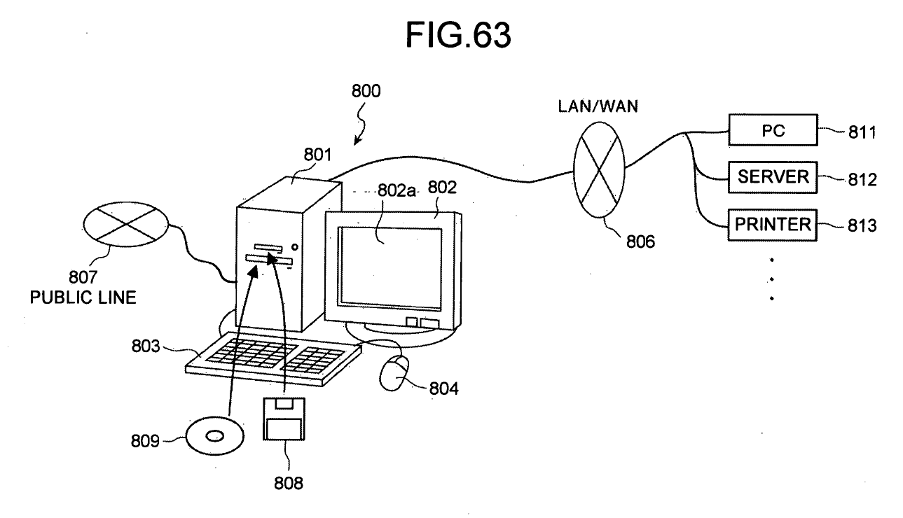

FIG. 63 is an illustration of the computer system that executes specification generating computer program according to the first to the seventh embodiments. As shown in FIG. 63, a computer system 800 includes a main section 801, a display 802, a keyboard 803, a mouse 804, a LAN interface, and a modem. The display 802 displays information on a display screen 802a according to instructions from the main section 801. The keyboard 803 is used to input various information to the computer system 800. By using the mouse 804, any desired position can be specified on the display screen 802a of the display 802. The LAN interface is connected to a LAN 806 or a wide area network (WAN). The modem is connected to a public line 807. In this case, the LAN 806 connects the computer system 800 with other computer systems 811 (e.g. PC), a server 812, and a printer 813.

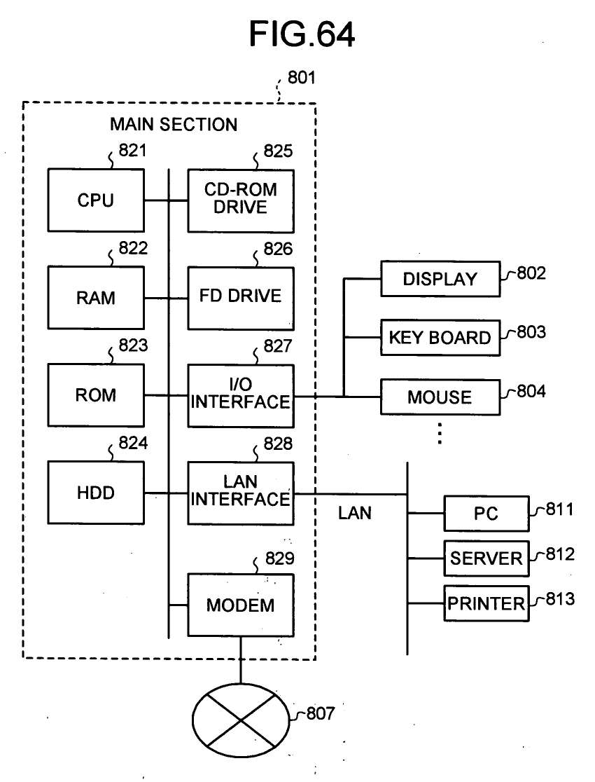

FIG. 64 is a block diagram of the main section 801 shown in FIG. 63. The main section 801 includes a CPU 21, a RAM 822, a ROM 823, a hard disc drive (HDD) 824, a CD-ROM drive 825, an FD drive 826, an I/O interface 827, a LAN interface 828, and a modem 829.

The specification generating computer program that is executed in the computer system 800 is stored in a portable recording medium like a floppy disc (FD) 808, a CD-ROM 809, a DVD disc, a magneto-optical disc, and an IC card. The specification generating computer program is read from the database and is installed in the computer system 800.

The specification generating computer program installed is stored in the HDD 824 and is executed by the CPU 821 by using the RAM 822, ROM 823 etc.

In the embodiments, the generation of specifications from a computer program that is developed in COBOL is described. However, the present invention is not restricted to the generation of specifications from a computer program developed in COBOL only, and is applicable similarly to the generation of specifications from a computer program that is developed in other computer programming languages like FORTRAN, C etc.

Thus, the specification creator, the method of specification generation, the specification generating computer program, and the recording medium that stores the computer program according to the present invention are useful for maintenance of the software, and are particularly suitable to understand the process-outline of a large scale computer program.

According to the present invention, the source computer program is analyzed and structure information with input and output that associates data input-output with the call structure of the computer program is generated. A part of the structure information with input and output generated is extracted and process-outline information of the source computer program is generated. Computer program specifications of the source program are generated by using the process-outline information of the source computer program generated. As a result, it is possible to have an overview of a software process, thereby facilitating software maintenance.

According to the present invention, structure information with input and output that associates the call structure of the computer program with call condition of the computer program. Further, process-outline information that associates the call structure of the computer program with the call condition of the computer program, is generated. The computer program specifications are generated by associating the call structure of the computer program with the call condition of the computer program. Therefore, it is easy to understand at which conditions there is input and output.

According to the present invention, a comment that is added by the user in a predetermined position in the computer program specifications generated is extracted. The comment extracted is inherited in a predetermined position in computer program specifications that are to be regenerated. As a result, the comment added to the program specifications by the user can be inherited automatically.

According to the present invention, outline information of the source computer program is generated by gathering together statements that are included in the source computer program. Computer program-outline statements in natural languages are generated from the computer program-outline information. Computer program-outline of the source computer program is generated by using the computer program-outline statements. As a result, the computer program process becomes easily understandable. Thus, the time taken for understanding is shorter.

According to the present invention, input-output information of job steps that are included in a batch job is extracted from a batch-job script that is described by a batch-job script language. Input information and output information of overall batch-job is specified based on input-output information of the job-steps extracted. Input information specified is input or a job-step that outputs the output information is specified. Computer program information that is called at the job-step specified is extracted. Batch-job process-outline of the batch-job is generated by using input information and output information specified and the information of the computer program extracted. As a result, understanding of outline of overall batch-job process is facilitated.

According to the present invention, screen transition information is generated by analyzing screen definitions that has defined information of the screen. A screen transition diagram is generated by using the screen transition information. As a result, understanding of process-outline of an online system is facilitated.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A computer program product including computer executable instructions stored on a computer readable medium, wherein the instructions, when executed by the computer, cause the computer to perform:
creating structure information that indicates a relation between a program call structure and data input-output information of the computer program source code by analyzing a computer program source code;
creating process-outline information of the computer program source code from a part of the structure information; and
creating computer program specifications of the computer program source code by using the process-outline information.

2. The computer program product according to claim 1, wherein
the creating of the process-outline information includes extracting information of a subroutine of a specific nesting level and data input-output information of the subroutine, and
the creating of the computer program specifications includes using the information of the subroutine and the data input-output information of the subroutine.

3. The computer program product according to claim 2, wherein the computer program specifications created include a call structure diagram in a tabular form that has a plurality of columns assigned to respective nesting levels of subroutines, wherein a name of each subroutine is shown in a column corresponding to a nesting level of the each subroutine.

4. The computer program product according to claim 1, wherein
the creating of the structure information includes creating structure information that indicates a relation between a program call structure and a program call condition,
the creating of the process-outline information includes creating process-outline information that indicates a relation between a program call structure and a program call condition, and
the creating of the computer program specifications includes creating computer program specifications that indicate a relation between a program call structure and a program call condition.

5. The computer program product according to claim 1, wherein the creating the computer program specification further includes
extracting a comment that is added by a user to a predetermined position in the computer program specifications created; and
adding the comment extracted to a predetermined position in computer program specifications to be created.

6. The computer program product according to claim 1, wherein the instructions further cause the computer to perform:
creating program-outline information of the computer program source code by summarizing statements included in the computer program source code;
creating a program-outline statement in a natural language from the program-outline information; and
creating a program-outline document of the computer program source code by using the program-outline sentence.

7. The computer program product according to claim 6, wherein the creating of the program-outline information includes
determining a significance level of data included in the computer program source code;
determining a significance level of a statement included in the computer program source code by using the significance level of data; and
summarizing statements included in the computer program source code by using the significance level of the statement.

8. The computer program product according to claim 1, wherein the instructions further cause the computer to perform:
extracting input-output information of a job step included in a batch job from a batch-job script described in a batch-job script language;
acquiring input information and output information of the overall batch job based on the input-output information of the job step;
specifying a job step at which the information acquired is input or output;
extracting information of a computer program called at the job step specified; and
creating batch-job process-outline information of the batch job by using the input information specified, the output information specified, and the information of the computer program extracted.

9. The computer program product according to claim 1, wherein the instructions further cause the computer to perform:
creating screen transition information by analyzing screen definitions which define information of a screen; and
creating a screen transition diagram by using the screen transition information.

10. The computer program product according to claim 9, wherein
the screen definitions include information of transition between the screen and a computer program expressed in the computer program source code, the screen transition information includes information of transition between the screen and the computer program, the instructions further cause the computer to perform:
creating merge diagram information in which the transition and input-output of the computer program are merged, by merging the screen transition information with the structure information, wherein
the creating of the screen transition diagram includes creating a diagram in which the transition and the input-output of the computer program are merged, by using the merge diagram information.

11. An apparatus for creating computer program specifications, comprising:
a first creator that creates structure information that indicates a relation between a program call structure and data input-output information of the computer program source code, by analyzing a computer program source code;
a second creator that creates process-outline information of the computer program source code from a part of the structure information; and
a third creator that creates computer program specifications of the computer program source code by using the process-outline information.

12. A method of creating computer program specifications, comprising:
creating, by analyzing a computer program source code, structure information that indicates a relation between a program call structure and data input-output information of the computer program source code;
creating process-outline information of the computer program source code from a part of the structure information; and
creating computer program specifications of the computer program source code by using the process-outline information.
